(19) United States
(12) Patent Application Publication
(10) Pub. No.: US 2024/0378586 A1
(43) Pub. Date: Nov. 14, 2024

(54) DYNAMIC USER INTERFACES AND OPERATIONAL FLOWS

(71) Applicant: Block, Inc., Oakland, CA (US)

(72) Inventors: Thuy Vu, Melbourne (AU); Rhoda Esquivel, Melbourne (AU); Bang Nguyen, Eschol Park (AU)

(21) Appl. No.: 18/316,179

(22) Filed: May 11, 2023

(51) Int. Cl. G06Q 20/32; G06Q 20/10; G06Q 20/38; G06Q 20/40

(52) U.S. Cl. CPC G06Q 20/3267; G06Q 20/108; G06Q 20/3821; G06Q 20/401

(57) ABSTRACT

Particular embodiments are directed to a payment service system associated with a payment service for facilitating recurring payment transactions to an external service utilizing a payment application. The payment service system receives a request to execute a payment transaction between a payor and a payee. The payment service system identifies, based on an identifier associated with the payee, a payee type for the payee, the payee type corresponding to a service provider having a payee account external to the payment service. The payment service system generates, based on the identified payee type for the payee, a transaction flow for executing the payment transaction, in which the transaction flow includes a customized sequence of user interactions to be performed to complete an execution to a payee having an account external to the payment service. In response to receiving one or more user inputs, the payment service system executes the payment transaction.

### TECHNICAL FIELD

Service providers may provide applications executable on client devices to enable users of the service to interact with and use the service. Client devices can include mobile devices and other electronic user devices. The application can include a user interface (UI) to facilitate user activity.

### BRIEF DESCRIPTION OF THE DRAWINGS

FIG. 1 is an example operating environment for providing dynamic user interfaces and operational flows according to embodiments disclosed herein.

FIGS. 2A-2D illustrate one or more examples of user interfaces for executing a transaction with an intended user according to embodiments disclosed herein.

FIGS. 3A-3D illustrate one or more examples of user interfaces for executing a transaction with an intended user according to embodiments disclosed herein.

FIGS. 4A-4D illustrate one or more examples of user interfaces for executing a transaction with an intended user identified based on an image identifier according to embodiments disclosed herein.

FIGS. 5A-5C illustrate one or more examples of user interfaces for executing a transaction with an intended user identified based on an image identifier according to embodiments disclosed herein.

FIGS. 6A-6D illustrate one or more examples of user interfaces for executing recurring transactions with an intended user according to embodiments disclosed herein.

FIG. 7 illustrates a flow diagram of a method for dynamically selecting or generating a payment transaction flow according to embodiments disclosed herein.

FIG. 8 illustrates a flow diagram of a method for identifying and requesting additional information from a user to execute a transaction with an intended user according to embodiments disclosed herein.

FIG. 9 illustrates a flow diagram of a method for training an artificial intelligence model to predict parameters to execute a transaction according to embodiments disclosed herein.

FIG. 10 illustrates an example environment for providing embodiments described herein.

FIG. 11 illustrates another example environment for providing embodiments described herein.

FIG. 12 illustrates an example datastore for providing embodiments described herein.

FIG. 13 illustrates another example environment for providing embodiments described herein.

FIG. 14 illustrates an example computer system for providing embodiments described herein.

### DETAILED DESCRIPTION

Techniques for generating, managing, updating, and/or the like dynamic user interfaces for operational flows are described herein. Techniques described herein relate to assets associated with accounts of users on and with services, such as online services, availed via networked computing devices and/or components associated with service providers, such as a payment service provider and payment service computing platform. Such services may be availed via applications running on user devices, such as a payment service application. In an example, the payment service and payment service computing platform may enable users to manage assets (e.g., funds, accounts, balances, payments, etc.) via such computing devices and/or components. In some examples, assets can correspond to funds, such as those stored in user accounts. Techniques described herein relate to dynamic user interfaces and operational flows associated with making payments, using such funds stored in user accounts, to a variety of payee types via a payment service application. The described techniques incorporate improvements to selecting and presenting user interfaces of said payment service application to improve the operation of the computing device executing the payment service application. Such improvements include dynamic modification of user interfaces presented via the payment service application and corresponding backend processing flows (e.g., operations) responsive to user input and predictions relating to the user's use of a simplified starting user interface that enables the user to use funds associated with their user account to make payments to a variety of payee types without indication of payee type.

The present techniques relate to integrating an external service provider and computing platform with the payment service and payment service computing platform to facilitate one-time and/or recurring payment transactions to the external service provider. In particular, different payment transaction flows (e.g., a payment transaction flow for payments between ordinary users, also known as “peer-to-peer” payments, distinct from a payment transaction flow for payments responsive to invoices or to service providers, for example, in exchange for goods or services provided by the external service providers) may be dynamically instantiated and presented through a unified user interface or sequence of user interfaces. Advantageously, the entire set of different user interactions and payment transaction flows may be performed and executed, at least from the perspective of the payor, all from within a unified payment service application and without having to exit the payment service application. As an example, and as described herein, a payment transaction flow may include a customized sequence of user interactions to be performed to complete an execution of a payment transaction between, for example, a payor having an account internal to the payment service and payment service computing platform and a payee having an account internal to the payment service and payment service computing platform or a payee having an account external to the payment service (e.g., an external service provider) and payment service computing platform.

In some examples, the payment service provider and payment service computing platform may utilize rules, associations or mappings, artificial intelligence models, and/or the like to determine whether a payor is intending to initiate a payment to an intended payee corresponding to another user having an account internal to the payment service provider and payment service computing platform or corresponding to an external service provider and computing platform, and may dynamically adjust the payment transaction flow accordingly. In one non-limiting example, the payment service provider and payment service computing platform may utilize one or more search engines to perform a search of a database of identifiers to identify an intended payee by comparing one or more identifiers inputted by the payor on the payment service application to identifiers stored in the database of identifiers. That is, in one example, the payment service provider and payment service computing platform can utilize rules, associations or mappings, and/or the like to identify the intended payee based on identifier(s) provided to initiate the payment. In an additional or alternative example, the payment service provider and payment service computing platform may utilize one or more artificial intelligence models to generate a prediction of an intended payee type based on context associated with the payment (e.g., one or more identifiers that may be associated with the intended payee type, an amount of the payment, a date of the payment, a time of the payment, payment history of the payor, a payment amount, recent interactions between the user and applications and/or webpages, an entry point or previous application and/or webpage from which the user accessed the payment service application, attachments associated with the payment, emojis and/or text description associated with the payment, and/or the like). The one or more artificial intelligence models may be trained to generate a prediction of an intended payee by way of, for example, one or more of text classification, image classification, and/or object detection. The use of artificial intelligence models to make predictions relating to the payor's intent for a transaction and to facilitate dynamic modifications of a payment service application user interface in real-time or near-time-real allows for continuous and on-demand improvement of the user interface in a manner that cannot be done through human activity. At the same time, it allows for each transaction and transaction flow to be customized to the payor, increasing the payor's engagement and familiarity with user interface. Increasing user engagement can be particularly beneficial when the user is initiating transactions with unfamiliar payees and/or is using a computing device with limited user input functionality or display availability.

In some examples, upon the one or more search engines or the one or more artificial intelligence models identifying that the intended payee is a payee type internal to the payment service and payment service computing platform, a user interface management component may dynamically select or generate a payment transfer transaction flow in accordance with the identified intended payee. In some examples, upon the one or more search engines or the one or more artificial intelligence models identifying the intended payee is a payee type external to the payment service and payment service computing platform, an application programming (API) management component may dynamically select or generate a payment transaction flow, such as a bill (or invoice) payment transaction flow. The bill payment transaction flow may be constructed from existing components of a bill payment transaction flow and used to modify a general or universal starting user interface that receives the initial user information used to derive the user's intent. In some examples, the one or more artificial intelligence models and API management component may access, for example, a database of payment transaction flow modules and select one of a number of predetermined or pre-generated payment transaction flows in accordance with the identified intended payee and a specified amount of funds for the intended payment transaction. In other examples, the API management component may access a database of payment transaction flow modules and generate a customized payment transaction flow by deriving in real-time or near real-time a customized payment transaction flow in accordance with the identified intended payee and a specified amount of funds for the intended payment transaction.

In accordance with the present techniques, the unified user interface or sequence of user interfaces may serve as an initiating point for a variety of different types of types of payment transactions, and thus customized payment transaction flows may be dynamically selected, generated, or modified according to a payee type of the intended payee and the type of payment transaction to be executed by the payor. The payment service and payment service computing platform may then, in accordance with the completed transaction flow, cause funds to be withdrawn from an account associated with the payor and transferred to an account of the identified payee in accordance with the one or more APIs, all from within a unified payment service application and without the payor having to exit the payment service application (i.e., to access another application for making the payment). In this way, the techniques described herein incorporate a reduction in misuse or overuse or computational resources and network bandwidth by ensuring that the payor is proceeding with the correct transaction flow to accomplish their intended task without the use of secondary executable components to initiate multiple additional information exchanges.

The present techniques may provide one or more technical improvements to a payment service and payment service computing platform and databases. For example, the present techniques may provide a unified user interface or sequence of user interfaces of a payment service application that facilitates both peer-to-peer payments and payments to an external service provider and computing platform. The unified user interface or sequence of user interfaces appear seamless to the payor, but backend services are employed to dynamically modify the payment transaction flow utilized by the payor based on the identification of a payee type of the intended payee. These backend services may include both calls to internally managed components (e.g., to determine or predict whether a payee identifier is associated with a payment service account or an external service) and to external components (e.g., API calls to other external services to confirm whether an identifier is associated with an external service). The unified user interface or sequence of user interfaces and payment transaction flow may reduce the number of redundant and/or unnecessary user interfaces the payment service application would otherwise present to the payor. The unified user interface or sequence of user interfaces and payment transaction flow may also make intelligent use of APIs and other system interaction features to streamline the information requested from the payor.

Techniques described herein can leverage specially configured hardware or software components associated with a payment service (e.g., a “network” or “platform”) to offer technical solutions to multiple technical problems identified in the field of providing online services, for example payment services, and in particular providing dynamic user interfaces and operational flows of mobile applications to facilitate user activity on online services in accordance with the description herein. For the purpose of this disclosure, unless specifically noted otherwise, operations attributed to the payment service may be performed by a payment service system comprising one or more computing devices and functional components of which are described below.

The techniques usable by online service providers, including payment services, use specialized hardware configured to perform the described operations in real-time or near real-time and while interacting with many users concurrently. The specialized hardware and processing techniques described herein are therefore integral to the performance of the techniques described herein. As will be appreciated, the operations require cooperation of multiple discrete components and data stores together in order to efficiently handle requests in a manner and timeliness that is expected of modern online services. Therefore, practically speaking, the techniques described herein cannot be performed by humans or by a single device acting alone.

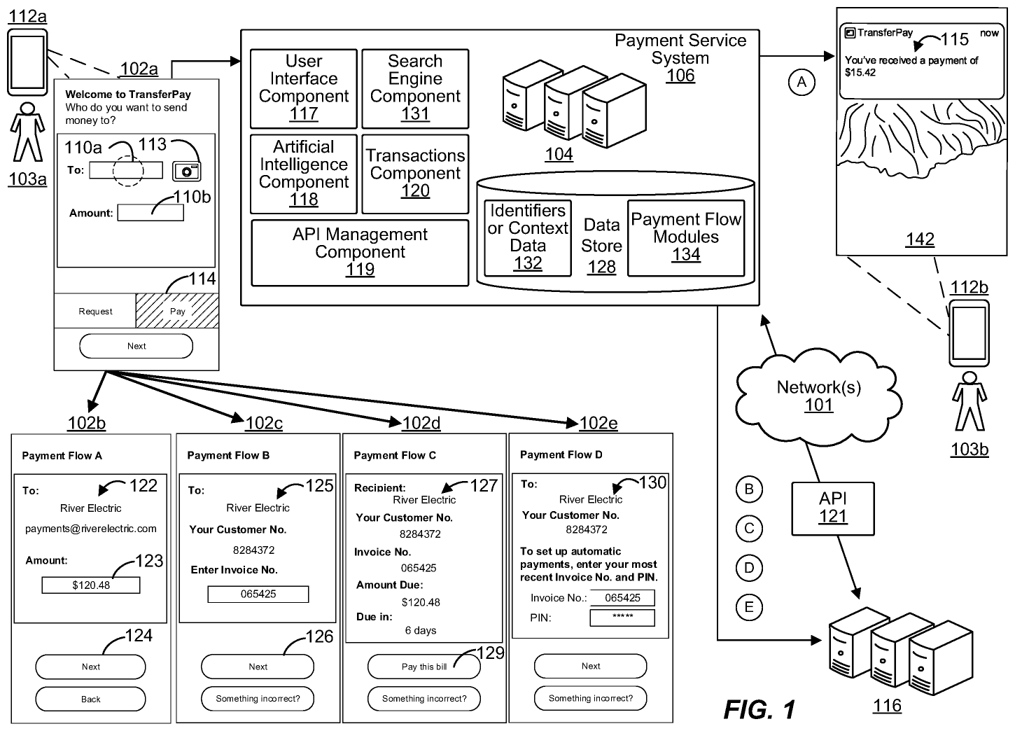

FIG. 1 illustrates an example operating environment for providing dynamic user interfaces and operational flows as discussed herein. The example environment 100 may include a payment service system 106. The payment service system 106 may include one or more servers 104 and a datastore 128 that may be suitable for exchanging electronic communications through network(s) 101 with one or more other computing devices. For example, the server(s) 104 or datastore 128 may exchange electronic communications with a user device 112a associated with a user, such as a payor 103a, by way of a payment service application (e.g., a mobile payment application) executing on the user device 112a and a user device 112b associated with a user, such as a payee 103b, by way of a payment service application (e.g., a mobile payment application) executing on the user device 112b.

The payment service application may be a respective instance of the payment service application provided by a payment service operating the payment service system 106 and executing on the user devices 112a, 112b. The payment service may be associated with the payment service system 106 such that operations described as being performed by the payment service may be performed by the payment service system 106. In some examples, the payment service system 106 may include a “backend” and the payment service application may be referred to as a “client” or “frontend.” In some examples, individual of the components described herein may include a “frontend” and other components may include a “backend.” In general, the components described herein as performing operations may be combined or divided, can have different names or functions, be used alone or in combination, be implemented by the server(s) 104 or user devices, and so on.

In some examples, a payor 103a may send a request to the payment service system 106 through the payment service application executing on the user device 112a. For example, a user interface component 117 may cause the payment service application to display a user interface 102 (e.g., 102a, 102b, 102c, 102d, 102e, or the like) on the user device 112a. In some examples, the user interface component 117 may include any user-facing web application and/or web application features (e.g., affordances, input controls, navigational elements, informational elements, and so forth) that may be suitable for causing the payment service application executing on the user device 112a to display the user interface 102 (e.g., 102a, 102b, 102c, 102d, 102e, or the like). The user interface component 117 may further allow the payor 103a to initiate a payment transaction, such as a request of funds, an execution of payments, such as payment transfers to a payee 103b (e.g., another user on the payment service system 106), bill payments, or utility payments, or a transfer of funds between different accounts on the payment service system 106 that are linked to the payor 103a. In some examples, by way of the user interface 102 (e.g., 102a, 102b, 102c, 102d, 102e, or the like), the user interface component 117 may allow the payor 103a to initiate a payment to any of various types of payees, such as payments to one or more payee(s) 103b on the payment service system 106, payments to business organizations or entities on the payment service system 106, or payments to entities external to the payment service system 106.

In some examples, as further depicted by the user interface 102a, the user interface component 117 may cause the user device 112a to display to the payor 103a the user interface 102a. In user interface 102a, one or more text fields 110a and 110b may presented for the payor 103a to initiate one payment transaction of a variety of types of payment transactions, such as a request of funds, an execution of a payment (e.g., to another user (e.g., a P2P payment), a bill payment, a utility payment, etc.), or a transfer of funds in accordance with the presently disclosed techniques. That is, the single user interface 102a acts as the initiating point for a variety of different types of types of payment transactions to different payee types. As described herein, the user interface 102 is dynamically selected, generated, or modified according to the type of payment transaction, as determined based on payee type, that the payment service system 106 detects as being requested by the payor 103a. For example, as illustrated by the user interface 102a, the payor 103a may initiate a payment transaction by selecting the text field 110a (e.g., “To: . . . ”) and inputting one or more characters corresponding to an identifier associated with an intended payee. As used herein, a “payee” may refer to an intended recipient payment transaction, including, but not limited to, a payment, a transfer of funds, a transfer of assets, or other similar payment transaction.

In some examples, in response to the payor 103a inputting a first few characters corresponding to a known intended payee into the text field 110a, the user interface component 117 may populate the text field 110a with an identifier corresponding to the intended payee. For example, as will be discussed in greater detail below, in response to the payor 103a inputting a first few characters (e.g., “my frie . . . ”) corresponding to a known intended payee (e.g., “My Friend”), a search engine component 131, utilizing, for example, one or more search algorithms or rules-based algorithms, may perform a search of a database of identifiers or context data 132 and the user interface component 117 may then populate the text field 110a with an identifier corresponding to the known intended payee (e.g., “My Friend”). In some examples, an identifier associated with an intended payee may include one or more of a name of the payee, a category of the payee, a physical address of the payee, a web address of the payee, a phone number of the payee, an email address of the payee, a digital signature of the payee, an image identifier associated with the payee, a tag identifier associated with the payee, a matrix barcode associated with the payee, or an account number of the payee.

A tag identifier associated with the payee may be identified by reference to a predetermined syntax determined by the user interface component 117, such as a known prefix followed by a set of characters matching a defined pattern (e.g., a prefix character “$” or “#”, followed by a set of alphanumeric characters) and in some examples may be referred to as a “usertag” as described herein). For example, the tag identifier can have a particular syntax, which can facilitate parsing by the user interface component 117 and easy identification by users. The syntax can include, for example, a monetary currency indicator (or “currency indicator”) prefixing one or more alphanumeric characters. The currency indicator operates as a tagging mechanism that indicates to the user interface component 117 and the transactions component 120 to treat the inputs as a request from the sender to initiate a transfer, where detection of the syntax (which includes one or more alphanumeric characters tagged by a monetary currency indicator) through monitoring triggers the transfer. The currency indicator can correspond to various currencies, e.g., dollar ($), euro (€), pound (£), rupee ( [symbol] ), yuan (v), etc.

As further depicted by the user interface 102 of FIG. 1, in some examples, the user interface 102 may include an image-capture icon 113. In some examples, the image-capture icon 113 may be selected by the payor 103a for the user interface component 117 to initiate, for example, an image capture of an identifier associated with an intended payee. In one example, the image-capture icon 113 may be selected by the payor 103a to cause the user interface component 117 to initiate an image capture of an identifier associated with an intended payee as displayed on, for example, a physical invoice in possession of the payor 103a. In another example, the image-capture icon 113 may be selected by the payor 103a to cause the user interface component 117 to initiate an image capture of a logo, a trademark symbol, a name or title, a stock trading ticker (e.g., stock trading symbol), a branding association indicator, a building, or other feature that may be utilized by the search engine component 131 or an artificial intelligence component 118 to detect and identify an intended payee. In some examples, upon the image capture of an identifier associated with an intended payee, the user interface component 117 populate the text field 110a with the identifier corresponding to the intended payee. In some examples, the payor 103a may also specify an amount of funds (e.g., a currency value or other asset value) for the intended payment transaction by inputting a currency value or asset value into the text field 110b (e.g., “Amount: . . . ”).

In some examples, based on an identifier or one or more characters indicative of an identifier associated with an intended payee as inputted into the text field 110a, the user interface component 117 may then provide an input to the search engine component 131 or the artificial intelligence component 118. In one example, the search engine component 131 may include one or more search engines that may be suitable for accessing and searching a database of known service identifiers 132 to identify the intended payee and determine a type of payee for the intended payee. In some examples, the intended payee may include any of various types of payees, such as one or more payee(s) on the payment service system 106, business organizations or entities on the payment service system 106, or entities external to the payment service system 106.

In some examples, the database of known service identifiers 132 may include a relational database including a large data set of identifiers associated with any of various types of payees as learned and stored overtime as, for example, different payors 103a execute payment transactions utilizing the payment service system 106. For example, the database of known identifiers or context data 132 (e.g., relational database) may be suitable for associating and storing any of various identifiers (e.g., names, titles, categories, physical addresses, web addresses, phone numbers, email addresses, social media handles, digital signatures, image identifiers, tag identifiers, account numbers, issuer identification numbers (IIINs), bank identification numbers (BIINs), logos, trademark symbols, stock trading tickers, branding association indicators, emojis, emoticons, or other similar features) that may be searchable and utilized by the search engine component 131 to search and identify a payee type of an intended payee or that may be utilized to train the artificial intelligence component 118 to predict a payee type of an intended payee by way of, for example, one or more of text classification, image classification, or object detection. In an additional example, the database of known identifiers or context data 132 (e.g., relational database) may include any of various context data, such as amounts of previous payment transactions, dates of previous payment transactions, times of previous payment transactions, payment history of the payor 103a or one or more other payors 103a, various user interactions between payors 103a and associated web applications, entry points from which the payors 103a access the payment service application, one or more attachments associated with previous payment transactions, one or more text-based descriptors (e.g., emoticons) associated with previous payment transactions, or one or more image-based descriptors (e.g., emojis) associated with previous payment transactions, and so forth.

In some examples, when the search engine component 131 identifies that the intended payee is a payee type internal to the payment service system 106 in response to a search of the database of known identifiers or context data 132, a dynamic payment transaction flow process may proceed in accordance with a payment transaction flow “A.” For example, upon the search engine component 131 identifying that the intended payee is a payee type internal to the payment service system 106, the user interface component 117 may access a database of payment transaction flow modules 134 and generate or select a payment transfer transaction flow in accordance with the identified intended payee and the specified amount of funds for the intended payment transaction as inputted into the text field 110b. In some examples, a payment transaction flow may include a customized sequence of user interactions to be performed to complete an execution of a payment transaction between, for example, the payor 103a having an account internal to the payment service system 106 and a payee 103b having an account internal to the payment service system 106 and/or the payor 103a having an account internal to the payment service system 106 and a payee (e.g., a service provider) having an account external to the payment service system 106.

In accordance with the selected payment transfer transaction flow as generated by the user interface component 117, a transactions component 120 may then proceed in executing a payment transaction by transferring an amount of funds from an account on the payment service system 106 associated with the payor 103a to an account on the payment service system 106 associated with the intended payee. For example, as depicted by the user interface 142, the user interface component 117 may then cause a payment service application executing on a user device 112b associated with an intended payee 103b to display the user interface 142, in which a notification 115 that the payment transaction (e.g., a transfer of funds) has been completed may be presented to the intended payee 103b (e.g., “You've received a payment $15.42”).

In some additional examples, the artificial intelligence component 118 may include a combination of hardware and software artificial intelligence accelerators for executing one or more machine-learning models (e.g., one or more of a univariate logistic regression model, a multivariate logistic regression model, a random forest model, a Naïve Bayes model, a gradient boosting model, a neural network, and so forth) or other predictive models that may be suitable for predicting, based on an identifier associated with an intended payee, a payee type for the intended payee. Specifically, the artificial intelligence component 118 may be suitable for 1) predicting a payee type for an intended payee, including an identification of the payee and whether the payee type has a payee account internal to the payment service system 106 or payee account external to the payment service system 106, and further 2) predicting a type of a service provider or other entity having a payee account external to the payment service system 106 as described in greater detail below.

In some examples, the artificial intelligence component 118 may include hardware (e.g., a general purpose processor, a graphic processing unit (GPU), an application-specific integrated circuit (ASIC), a system-on-chip (SoC), a microcontroller, a field-programmable gate array (FPGA), a central processing unit (CPU), an application processor (AP), a visual processing unit (VPU), a neural processing unit (NPU), a neural decision processor (NDP), a tensor processing unit (TPU), a neuromorphic processing unit (NPU), a deep-learning processor (DLP), and/or other artificial intelligence accelerator that may be suitable for processing various transaction data and financial data and making one or more predictions based thereon), software (e.g., instructions running/executing on one or more processing devices), firmware (e.g., microcode), or some combination thereof. For example, the artificial intelligence component 118 that may identify a payee type of an intended payee by accessing one or more identifiers associated with an intended payee from the database of identifiers or context data 132, inputting the one or more identifiers into the artificial intelligence component 118 trained to generate a prediction of payee type based on identifiers associated with a payee, and causing the artificial intelligence component 118 to output the prediction of a payee type for the intended payee based on the one or more identifiers.

In some examples, the prediction of a payee type for an intended payee as generated by the artificial intelligence component 118 may include a prediction of whether the intended payee corresponds to a service provider or other entity having a payee account external to the payment service system 106 (e.g., an external payee type) or the intended payee corresponds to a payee having an internal payee account (e.g., an internal payee type). Note, additional or alternative payee types are within the scope of this disclosure (e.g., a for-profit payee type, a non-profit payee type, an individual user payee type, a corporate payee type, and so on). In one example, the artificial intelligence component 118 may generate the prediction of whether the intended payee corresponds to a service provider or other external entity or the intended payee corresponds to a payee having an internal payee account based solely on one or more identifiers associated with an intended payee. In another example, the artificial intelligence component 118 may generate the prediction of whether the intended payee corresponds to a service provider or other external entity or the intended payee corresponds to a payee having an internal payee account based on context, as described below. Context may include one or more identifiers that may be associated with the intended payee type, an amount of the payment, a date of the payment, a time of the payment, payment history of the payor, a payment amount, recent interactions between the user and applications and/or webpages, an entry point or previous application and/or webpage from which the user accessed the payment service application, attachments associated with the payment, emojis and/or text description associated with the payment, and/or the like.

In some examples, training data including context and payee types may be utilized to train models that can be used by the artificial intelligence component 118 to generate a prediction of whether the intended payee corresponds to a service provider or other external entity or the intended payee corresponds to a payee having an internal payee account. Examples of context are provided above. Additional details about context are provided below. Identifiers are described above, and, in some examples, may be used as context for predicting payee type. In an additional or alternative example, an amount of the specified amount of funds for the requested payment transaction may be used to determine a payee type. For example, an amount of $2,000 may indicate a payment to an external housing provider (e.g., rent payment, mortgage payment) while an amount $100 or less may indicate a payment to an internal intended payee 103b. In some examples, a date of the requested payment transaction may be utilized as context. For example, a payment transaction requested on the 1^{st}, 15^{th}, or 30^{th} may indicate a payment to an external service provider, such as a utility service provider. For instance, if, based on historical data, a user makes a payment on a same date at a recurring frequency, such a date and recurrence may indicate an external payee type. In another example, an integer payment amount or a fractional payment amount relative to a particular currency may be utilized as context. For example, an integer value amount may indicate a payment to an internal intended payee 103b, while a fractional payment amount may indicate a payment to a service provider or other external entity. Similarly, in some examples, a time of the requested payment transaction may be utilized as context. For example, a payment transaction requested during typical lunch hours (e.g., 11:00 am-2:00 pm) or dinner hours (e.g., 5:00 pm-8:00 pm) may indicate a payment to an internal intended payee 103b, while a payment transaction requested during the wee hours of a Friday morning (e.g., corresponding to a time one or more payors 103a may receive ACH deposits) may indicate a payment to a service provider or other external entity. In some examples, a payment history of the payor 103a may be utilized as context. For example, a series of payments to a same or repeated intended payee may indicate a payment to a service provider or other external entity or a cluster of payment transactions having occurred around the same time may indicate a payment to a service provider or other external entity. In some examples, recent interactions between the payor 103a and applications and/or webpages may be utilized as context. For example, the payor 103a having recently accessed a billing payment portal or webpage may indicate a payment to a service provider or other external entity. Lastly, in some examples, attachments associated with requested payment transactions, an entry point or previous application and/or webpage from which the payor 103a accessed the payment service application, emojis, emoticons, and/or text-based descriptors or image-based descriptors associated with requested payment transactions may be utilized as context.

In some examples, context and/or payee types may be utilized to train the artificial intelligence component 118 to generate a prediction of a type of a service provider or other entity having a payee account external to the payment service system 106 and may include, for example, names, titles, categories, physical addresses, web addresses, phone numbers, email addresses, social media handles, digital signatures, image identifiers, tag identifiers, account numbers, IINs, BIINs, logos, trademark symbols, stock trading tickers, text-based or image-based branding association indicators (e.g., advertising slogans, advertising jingles, advertising mascots, digital or physical advertisements, a specific color, and so forth), emojis, emoticons, geographical locations, or other similar features that may be utilized to train the artificial intelligence component 118 to predict a type of a service provider or other entity having a payee account external to the payment service system 106 by way of, for example, one or more of text classification, image classification, or object detection. In some examples, such identifiers can be used to predict the payee in addition to, or as an alternative of, predicting payee type.

That is, as delineated by the foregoing, in some examples, the artificial intelligence component 118 may be trained to generate a prediction of an intended payee type based on a context (e.g., an amount of the specified amount of funds for a requested payment transaction, a date of a requested payment transaction, a time of a requested payment transaction, a payment history of the payor 103a and/or the internal intended payee 103b, recent interactions between the payor 103a and applications and/or webpages, attachments associated with requested payment transactions, emojis, emoticons, and/or text descriptors associated with requested payment transactions, and so forth) associated with a payment transaction requested by the payor 103a while, in other examples, the artificial intelligence component 118 may be trained to generate a prediction of an intended payee type, or even payee, based on identifiers (e.g., names, titles, categories, physical addresses, web addresses, phone numbers, email addresses, social media handles, digital signatures, image identifiers, tag identifiers, account numbers, IINs, BIINs, logos, trademark symbols, stock trading tickers, text-based or image-based branding association indicators, geographical locations, or other similar features) associated with an intended payee.

In some examples, as generally discussed above, the artificial intelligence component 118 may further predict a type of the service provider or other entity having a payee account external to the payment service system 106. For example, the artificial intelligence component 118 may predict whether the service provider or other external entity is one of a utility service provider (e.g., electricity, gas, water, and so forth), a housing provider, a credit card issuer, an external banking service, a telecommunications service provider, a video-streaming service provider, a health insurance provider, an auto loan provider, an auto insurance provider, a medical provider, or other type of service provider or external entity to which the payor 103a may execute recurring payment transactions. Specifically, by predicting a type of the service provider or other external entity, the present techniques may allow an application programming interface (API) management component 119 to dynamically select or generate an associated payment transaction flow for each type of service provider or other external entity. For example, as will be discussed in greater detail below, based on a prediction by the artificial intelligence component 118 that the service provider or other external entity is a utility service provider or a telecommunications service provider, the API management component 119 may select or generate a payment transaction flow in which the user interface sequence includes one or more prompts for the payor 103a to input additional billing identification information such as, a biller code, a customer reference number, or an account number.

In another example, based on a prediction by the artificial intelligence component 118 that the service provider or other external entity is a credit card issuer or an auto loan provider, the API management component 119 may select or generate a payment transaction flow in which the user interface sequence includes one or more prompts for the payor 103a to input additional billing identification information (e.g., a biller code, a customer reference number, an account number), as well one or more prompts for the payor 103a to input additional personal identification information (e.g., social security number, personal identification number (PIN), password) or personal identification inputs (e.g., face image, biometric input, two-factor authentication, eye position or eye gaze) since these payee types may potentially impact the consumer credit rating of the payor 103a.

In some examples, the artificial intelligence component 118 may be trained to generate a prediction of a payee type of an intended payee or a type of a service provider or other entity having an external payee account by computing a loss function based on whether a payment transaction is executed and completed. In one example, the loss function may be configured to indicate the prediction of the payee type for the intended payee or the type of a service provider or other entity having an external payee account as being correct in response to an execution of the payment transaction and to indicate the prediction of the payee type or the type of a service provider or other entity having an external payee account for the payee as being incorrect in response to the payment transaction not being executed. For example, the artificial intelligence component 118 may include one or more reward models, which may be trained in accordance with a reinforcement learning (RL) process. For example, in accordance with an RL process, the artificial intelligence component 118 may be “rewarded” for payment transactions executed and completed and “penalized” for payment transactions not executed and completed. In some examples, the artificial intelligence component 118 may be iteratively updated (e.g., fine-tuned) based on the computed loss function.

In some examples, as further depicted by FIG. 1, upon the artificial intelligence component 118 generating a prediction of a payee type in which the intended payee corresponds to a service provider or other external entity, a dynamic payment transaction flow process may proceed in accordance with an illustrated bill payment transaction flow “B”, “C”, “D”, and “E”. For example, the prediction as generated by the artificial intelligence component 118 may be provided to the API management component 119. In some examples, the API management component 119 may include, for example, a set of defined rules suitable for allowing the payment service system 106 to exchange data (e.g., transactions data, communications protocol data) with one or more third-party servers 116 by way of one or more APIs 121. For example, the one or more third-party servers 116 may be associated with an intended payee corresponding to a service provider or other entity having a payee account external to the payment service system 106.

In some examples, as illustrated by the bill payment transaction flow “B”, “C”, “D”, and “E”, upon the artificial intelligence component 118 generating a prediction of a payee type in which the intended payee corresponds to a service provider or other external entity, the API management component 119 may access the database of payment transaction flow modules 134 and dynamically select or generate a bill payment transaction flow in accordance with the identified intended payee and a specified amount of funds for the intended payment transaction. In some examples, the database of payment transaction flow modules 134 may include a relational database, which may store and update sets of payment transaction flows for differing payee types as the sets of payment transaction flows are generated, selected, and utilized by the API management component 119. As depicted by the payment transaction flow “B,” the artificial intelligence component 118 may identify an intended payee (e.g., “River Electric”) based on an identifier (e.g., “payments@riverelectric.com”), for example, and the user interface component 117 may populate the identified intended payee (e.g., “River Electric”) and a specified amount of funds (e.g., “$120.48”) for the intended payment transaction as inputted by the payor 103a.

In some examples, the API management component 119 may access the database of payment transaction flow modules 134 and select one of a number of predetermined or pre-generated payment transaction flows in accordance with the identified intended payee and a specified amount of funds for the intended payment transaction. In other examples, the API management component 119 may access the database of payment transaction flow modules 134 and generate a customized payment transaction flow by deriving in real-time or near real-time a customized payment transaction flow in accordance with the identified intended payee and a specified amount of funds for the intended payment transaction. In one example, the API management component 119 may generate a customized payment transaction flow by combining processes associated with the number of predetermined or pre-generated payment transaction flows as accessed from the payment transaction flow modules 134.

In some examples, in response to the payor 103a selecting an affordance 124 (e.g., “Next”) confirming the identified intended payee (e.g., “River Electric”) and a specified amount of funds (e.g., “$120.48”) for the intended payment transaction as inputted by the payor 103a, as further depicted by the payment transaction flow “C,” the user interface component 117 may then present a prompt for the payor 103a to input additional information 125 associated with the payment transaction. For example, the user interface component 117 may present a prompt for the payor 103a to input additional information 125, such as one or more of a biller code (e.g., “065425”), a customer reference number (e.g., “8324372”), an account number, a personal identification number (PIN), an image (e.g., an image of a physical billing invoice, a face image of the payor 103a, an image of a quick response (QR) code, an image of a barcode, a snapshot of a virtual object, and so forth), or a biometric identifier (e.g., a fingerprint of the payor 103a, a palm print of the 103a, an eye position or eye gaze of the payor 103a, and so forth).

In some examples, in response to the payor 103a inputting the additional information 125 and selecting an affordance 126 (e.g., “Next”) confirming the inputted additional information 125, as further depicted by the payment transaction flow “D,” the user interface component 117 may then present a confirmation user interface 127 for the payor 103a to visually verify and confirm the identified intended payee (e.g., “River Electric”), the specified amount of funds (e.g., “$120.48”) for the intended payment transaction, and the additional information 125. In some examples, in response to the payor 103a selecting an affordance 129 (e.g., “Pay this Bill”) confirming that the payor 103a would like to proceed in executing a payment transaction to the identified intended payee (e.g., “River Electric”), as further depicted by the payment transaction flow “E,” the API management component 119 may then exchange transactions data and communications protocol data between the payment service system 106 and the one or more third-party servers 116 by way of the one or more APIs 121. In some examples, the API management component 119 may be configured to automatically instantiate the one or more APIs 121 for exchanging transactions data and communications protocol data between the payment service system 106 and the one or more third-party servers 116 responsive to the payor 103a selecting the affordance 129 (e.g., “Pay this Bill”).

In some examples, the transactions component 120 may then proceed in executing a payment transaction by transferring the specified amount of funds (e.g., “$120.48”) from an account on the payment service system 106 associated with the payor 103a to an account external to the payment service system 106 associated with the identified intended payee (e.g., “River Electric”) in accordance with the one or more APIs 121. In some examples, as further depicted by the payment transaction flow “E,” upon completion of the payment transaction, the user interface component 117 may present a prompt 130 for allowing the payor 103a to set up automatic recurring payment transactions (e.g., over monthly billing cycles, bi-monthly billing cycles, or semi-annual billing cycles) to the identified intended payee (e.g., “River Electric”). In some examples, the payor 103a may be prompted to input a PIN or other similar personal identification data to approve and confirm the setup of automatic recurring payment transactions.

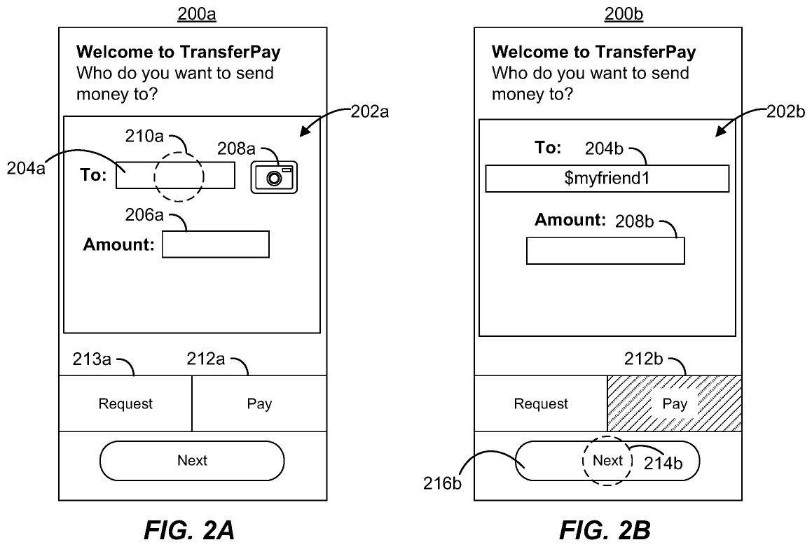

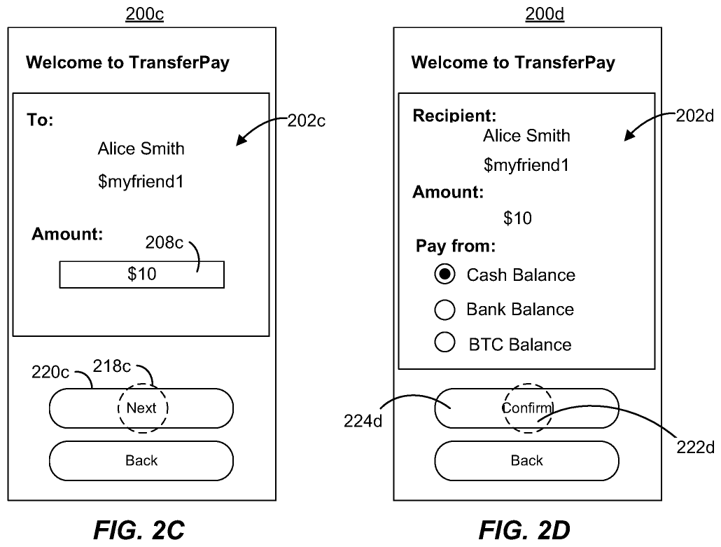

FIGS. 2A-2D illustrate one or more examples of user interfaces 200a, 200b, 200c, and 200c for identifying a payee type of an intended payee when the intended payee has an account internal to a payment service, and further executing a payment transaction to the intended payee, in accordance with presently disclosed embodiments. For example, example user interface 200a includes a user interface 202a illustrating that a payor 103a wishes to execute a payment transaction. User interface 202a may be the general payment transaction user interface provided by the payment application. As described in further detail herein, the same general payment transaction user interface can be adapted, modified, customized, or otherwise used to perform many different types of payment transactions to many different payees and types of payees. The user interface of this type may be referred to as a “universal” payment transaction user interface.

As depicted, in some examples, the user interface 202a may include a text field 204a suitable for allowing the payor 103a to input an identifier to identify an intended payee, a text field 206a suitable for allowing the payor 103a to input a specified amount of funds (e.g., a currency value, an asset value) to be transferred to the intended payee, and an image-capture icon 208a that may be selected by the payor 103a to initiate, for example, an image capture of an identifier associated with an intended payee. As further depicted by FIG. 2A, the user interface 202a may also include one or more affordances 212a, 213a (e.g., an “affordance” includes a selectable user interface element indicating the action to be performed by its selection) suitable for allowing the payor 103a to “Request” a payment of funds or “Pay” or send a payment of funds.

Referring to FIG. 2B, the example user interface 200b illustrates that the payor 103a may input into a text field 204b an identifier (e.g., “$myfriend1”) or a first few characters (e.g., “myfrie. . . . ”) of an identifier corresponding to an intended payee having an account internal to the payment service system 106. The payor 103a may then select an affordance 212b (e.g., “Pay”) indicating that the payor 103a wishes to send a payment and select by user input 214b an affordance 216b (e.g., “Next”) indicating that the payor 103a has completed inputting the identifier into the text field 204b. In some examples, in response to the payor 103a selecting the affordance 216b (e.g., “Next”), the example user interface 200c may be presented as depicted by FIG. 2C. As depicted by FIG. 2C, the example user interface 200c illustrates that the payment service system 106 has identified an intended payee (e.g., “Alice Smith”) based on the inputted identifier (e.g., “myfriend1”). The intended payee may be identified as having an account internal to the payment service system 106. The name or other information identifying the payee may be retrieved from one or more datastores 128 and presented to the payor 103a for verification. The payor 103a may input into a text field 208c a specified amount of funds (e.g., “$10”) to be transferred to the intended payee (e.g., “Alice Smith”).

The payor 103a may then select by user input 218b an affordance 220c (e.g., “Next”) indicating that the payor 103a has completed inputting the specified amount of funds (e.g., “$10”) into the text field 208c. In some examples, in response to the payor 103a selecting the affordance 220c (e.g., “Next”), the example user interface 200d may be presented as depicted by FIG. 2D. As depicted by FIG. 2D, the example user interface 200d illustrates that the intended payee (e.g., “Alice Smith”) is to be transferred a specified amount of funds (e.g., “$10”) from a cash balance of the payor 103a. The payor 103a may then select by user input 222d an affordance 224d (e.g., “Confirm”) confirming that the payor 103 wishes to complete the execution of the payment transaction, and an account on the payment service system associated with the intended payee (e.g., “Alice Smith”) may be then transferred a specified amount of funds (e.g., “$10”) from a cash balance account on the payment service system 106 associated with the payor 103a.

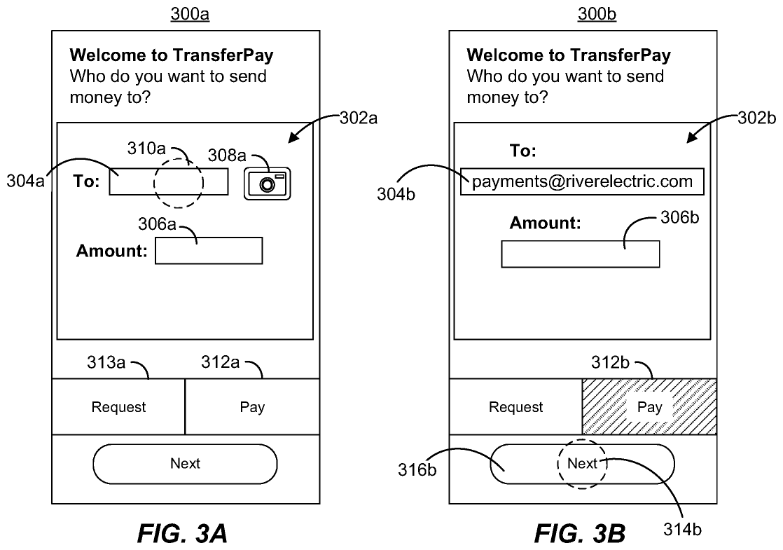

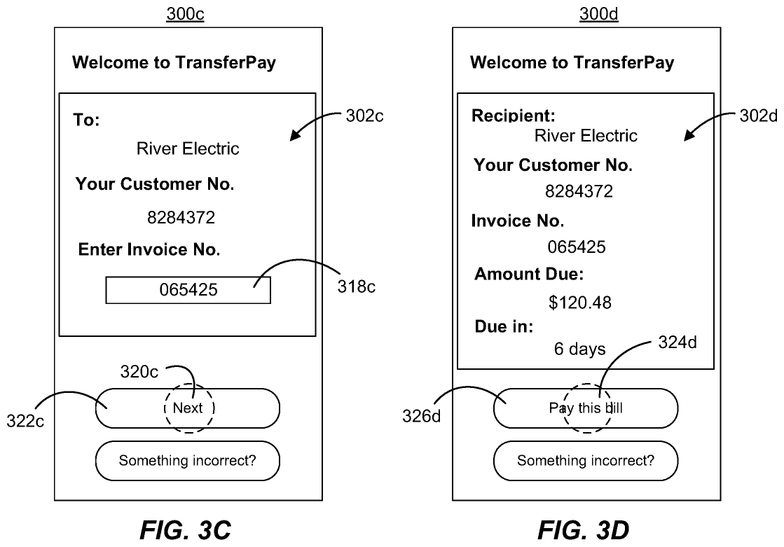

FIGS. 3A-3D illustrate one or more examples of user interfaces 300a, 300b, 300c, and 300d for identifying a payee type of an intended payee when the intended payee has an account external to a payment service, and further executing a payment transaction to the intended payee, in accordance with presently disclosed embodiments. For example, and similar to example user interface 200a, example user interface 300a includes a user interface 302a illustrating that a payor 103a wishes to execute a payment transaction. The user interface 300a may be another instance of a “universal” payment transaction user interface. As depicted, the user interface 302a may include a text field 304a suitable for allowing the payor 103a to input an identifier to identify an intended payee, a text field 306a suitable for allowing the payor 103a to input a specified amount of funds (e.g., a currency value, an asset value) to be transferred to the intended payee, and an image-capture icon 308a that may be selected by the payor 103a to initiate, for example, an image capture of an identifier associated with an intended payee. As further depicted by FIG. 3A, the user interface 302a may also include one or more affordances 312a, 313a suitable for allowing the payor 103a to “Request” a payment of funds or “Pay” or send a payment of funds.

Referring to FIG. 3B, the example user interface 300b illustrates that the payor 103a may input into a text field 304b an identifier (e.g., “payments@riverelectric.com”) of an identifier corresponding to an intended payee having an account external to the payment service system 106. While FIG. 3B has an example of an email address, the identifier may be less explicit or more ambiguous—such as a phone number, business name, or the like. The payor 103a may then select an affordance 312b (e.g., “Pay”) indicating that the payor 103a wishes to send a payment and select by user input 314b an affordance 316b (e.g., “Next”) indicating that the payor 103a has completed inputting the identifier into the text field 304b. In some examples, in response to the payor 103a selecting the affordance 316b (e.g., “Next”), the example user interface 300c may be presented as depicted by FIG. 3C.

In response to the payor 103a selecting the affordance 316, the user interface component 117 may provide the identifier input into the text field 304b to the artificial intelligence component 118. The artificial intelligence component 118 may attempt to identify the intended payee based on the identifier. The artificial intelligence component 118 may attempt to identify the payee type of the intended payee. As an example, the artificial intelligence component 118 may attempt to retrieve data corresponding to the identifier from the set of identifiers or context data 132 stored in the data store 128. The data may include the payee type. Based on the retrieved data, the artificial intelligence component 118 may select, generate, modify, or otherwise prepare a transaction flow corresponding to a predicted transaction intended by the payor 103a. As an example, the artificial intelligence component 118 may select a set of payment flow modules 134 from the data store, modify the selected payment flow modules 134 and user interface components associated with the selected payment flow modules 134, and cause the user interface component 117 to present the user interface components. As described herein, in some examples, the artificial intelligence component 118 may not be able to identify the intended payee based on the identifier and may generate transaction flows corresponding to requesting additional information from the payor 103a to facilitate the identification.

As depicted by FIG. 3C, the example user interface 300c illustrates that an intended payee (e.g., “River Electric”) may be identified based on the inputted identifier (e.g., “payments@riverelectric.com”) as having an account external to the payment service system 106. In some examples, upon the determining that the intended payee (e.g., “River Electric”) has an account external to the payment service system 106, as further depicted by FIG. 3C, the example user interface 300c may include a prompt for the payor 103a to input into a text field 318c additional information, such as a biller code or invoice number “065425.” The determination to include the prompt for the payor 103a to input the additional information is based on the transaction flow selected and/or generated by the artificial intelligence component 118. The example user interface 300c may also populate and display a customer reference number or account number (e.g., “8284372”) corresponding, for example, to a preestablished service account of the payor 103a with respect to the intended payee (e.g., “River Electric”). The preestablished service account may be identified, for example, after determining the intended payee and referencing additional data stored in a user profile of the payor 103a.

The payor 103a may then select by user input 320c an affordance 322c (e.g., “Next”) indicating that the payor 103a has completed inputting the additional information (e.g., biller code or invoice number “065425”) into the text field 318c. In some examples, in response to the payor 103a selecting the affordance 322c (e.g., “Next”), the example user interface 300d may be presented as depicted by FIG. 3D. As depicted by FIG. 3D, the example user interface 300d illustrates that a payment transaction between the payor 103a and the intended payee (e.g., “River Electric”) is to be executed in accordance with an invoiced billing amount (e.g., “$120.48”). The invoiced billing amount may be automatically retrieved by the API management component 119 using the additional information provided by the user interface component 117. For example, the API management component 119 may query a system provided by the intended payee using the additional information and other information stored in the data store 128 to identifier the information such as the billing amount, due date, and other information to facilitate and verify the transaction. The payor 103a may then select by user input 324d an affordance 326d (e.g., “Pay this Bill”) confirming that the payor 103a wishes to complete the execution of the payment transaction to the intended payee (e.g., “River Electric”) to satisfy the invoiced billing amount (e.g., “$120.48”). In accordance with the presently disclosed techniques, transactions component 120 may cause the account of the intended payee (e.g., “River Electric”) external to the payment service system 106 to be transferred an amount of funds (e.g., “$120.48”) from an account of the payor 103a internal to the payment service system 106.

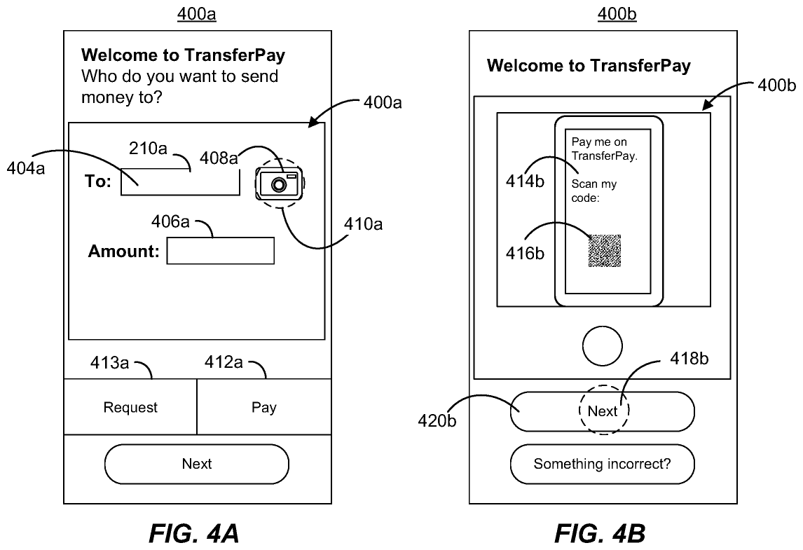

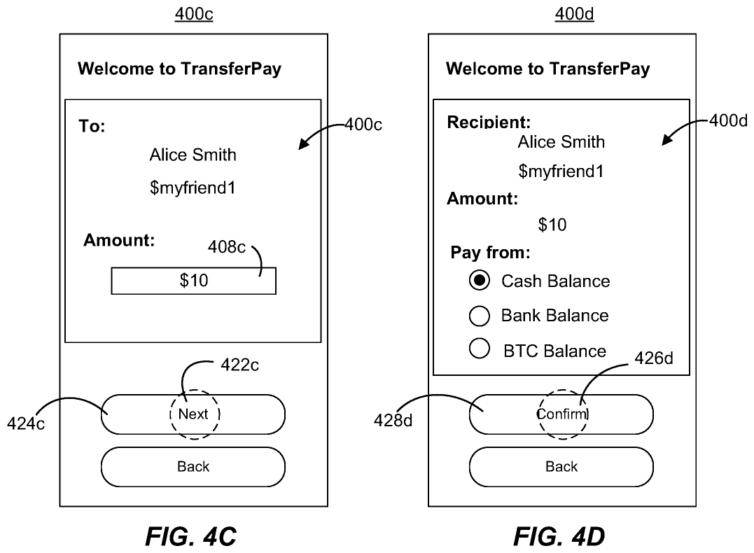

FIGS. 4A-4D illustrate one or more examples of user interfaces 400a, 400b, 400c, and 400d for identifying a payee type based on an image identifier of an intended payee when the intended payee has an account internal to a payment service, and further executing a payment transaction to the intended payee, in accordance with presently disclosed embodiments. For example, and similar to example user interface 200a and example user interface 300a, example user interface 400a includes a user interface 402a illustrating that a payor 103a wishes to execute a payment transaction. As depicted, the user interface 402a may include a text field 404a suitable for allowing the payor 103a to input an identifier to identify an intended payee, a text field 406a suitable for allowing the payor 103a to input a specified amount of funds (e.g., a currency value, an asset value) to be transferred to the intended payee, and an image-capture icon 408a that may be selected by the payor 103a to initiate, for example, an image capture of an identifier associated with an intended payee. As further depicted by FIG. 4A, the user interface 402a may also include one or more affordances 412a, 413a suitable for allowing the payor 103a to “Request” a payment of funds or “Pay” or send a payment of funds. The example user interface 400a further illustrates that the payor 103a may select by user input 410a the image-capture icon 408a to initiate, for example, an image capture of an identifier associated with an intended payee.

Referring to FIG. 4B, the example user interface 400b illustrates that the payor 103a may be then presented an image 414b including an image identifier 416b (e.g., a QR code, a barcode, a data matrix code, and so forth) associated with an intended payee as captured by the user device 112a, for example. The image identifier 416b may be generated, for example, by an instance of the payment application executing on a user device of the intended payee. The payor 103a may then select by user input 418b an affordance 420b (e.g., “Next”) indicating that the payor 103a has completed capturing the image identifier 416b associated with the intended payee. In some examples, in response to the payor 103a selecting the affordance 420b (e.g., “Next”), the example user interface 400c may be presented as depicted by FIG. 4C. As depicted by FIG. 4C, the example user interface 400c illustrates that an intended payee (e.g., “Alice Smith”) may be identified based on the image identifier 416b as having an account internal to the payment service system 106, and then the payor 103a may input into a text field 408c a specified amount of funds (e.g., “$10”) to be transferred to the intended payee (e.g., “Alice Smith”).

The payor 103a may then select by user input 422b an affordance 424c (e.g., “Next”) indicating that the payor 103a has completed inputting the specified amount of funds (e.g., “$10”) into the text field 408c. In some examples, in response to the payor 103a selecting the affordance 424c (e.g., “Next”), the example user interface 400d may be presented as depicted by FIG. 4D. As depicted by FIG. 4D, the example user interface 400d illustrates that the intended payee (e.g., “Alice Smith”) is to be transferred a specified amount of funds (e.g., “$10”) from a cash balance of the payor 103a. The payor 103a may then select by user input 426d an affordance 428d (e.g., “Confirm”) confirming that the payor 103 wishes to complete the execution of the payment transaction, and an account on the payment service system associated with the intended payee (e.g., “Alice Smith”) may be then transferred a specified amount of funds (e.g., “$10”) from a cash balance account on the payment service system 106 associated with the payor 103a.

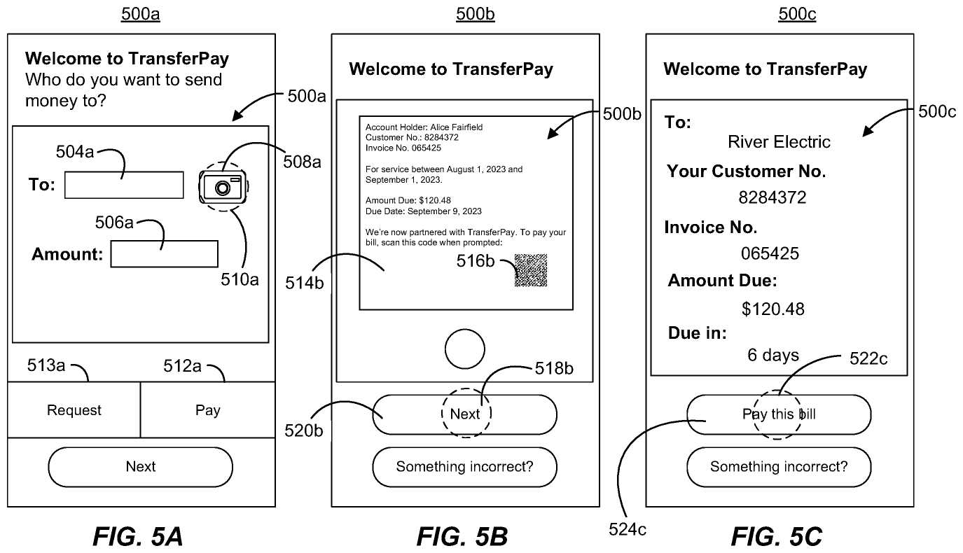

FIGS. 5A-5C illustrate one or more examples of user interfaces 500a, 500b, and 500c for identifying a payee type based on an image identifier of an intended payee when the intended payee has an account external to a payment service, and further executing a payment transaction to the intended payee, in accordance with presently disclosed embodiments. For example, and similar to example user interface 200a, example user interface 300a, and example user interface 400a, example user interface 500a includes a user interface 502a illustrating that a payor 103a wishes to execute a payment transaction. As depicted, the user interface 302a may include a text field 504a suitable for allowing the payor 103a to input an identifier to identify an intended payee, a text field 506a suitable for allowing the payor 103a to input a specified amount of funds (e.g., a currency value, an asset value) to be transferred to the intended payee, and an image-capture icon 508a that may be selected by the payor 103a to initiate, for example, an image capture of an identifier associated with an intended payee. As further depicted by FIG. 5A, the user interface 502a may also include one or more affordances 512a, 513a suitable for allowing the payor 103a to “Request” a payment of funds or “Pay” or send a payment of funds. The example user interface 500a further illustrates that the payor 103a may select by user input 510a the image-capture icon 508a to initiate, for example, an image capture of an identifier associated with an intended payee.

Referring to FIG. 5B, the example user interface 500b illustrates that the payor 103a may be then presented an image 514b including an image identifier 516b (e.g., a QR code, a barcode, a data matrix code, and so forth) associated with an intended payee as captured by the user device 112a, for example. In one example, the image 514b captured by the payor 103a utilizing the user device 112a may include an image of a physical invoice in possession of the payor 103a. In another example, the image 514b captured by the payor 103a utilizing the user device 112a may include an image of a logo, a trademark symbol, a name or title, a building, a stock trading ticker (e.g., stock trading symbol), a branding association indicator, or other feature that may be utilized by the artificial intelligence component 118 to detect and identify the intended payee. The payor 103a may then select by user input 518b an affordance 520b (e.g., “Next”) indicating that the payor 103a has completed capturing the image identifier 516b associated with the intended payee.

In some examples, in response to the payor 103a selecting the affordance 520b(e.g., “Next”), the example user interface 500c may be presented as depicted by FIG. 5C. As depicted by FIG. 5C, the example user interface 500c illustrates that an intended payee (e.g., “River Electric”) may be identified based on the captured image identifier 516b as having an account external to the payment service system 106. In some examples, upon identifying the intended payee (e.g., “River Electric”) based on the captured image identifier 516b, as further depicted by FIG. 5C, the example user interface 300c may populate and display a customer reference number or account number (e.g., “8284372”), a biller code or invoice number (e.g., “065425”), and an invoiced billing amount (e.g., “$120.48”) corresponding, for example, to a preestablished service account of the payor 103a with respect to the intended payee (e.g., “River Electric”).

In some examples, the example user interface 500c further illustrates that a payment transaction between the payor 103a and the intended payee (e.g., “River Electric”) is to be executed in accordance with the invoiced billing amount (e.g., “$120.48”). The payor 103a may then select by user input 522c an affordance 524c (e.g., “Pay this Bill”) confirming that the payor 103 wishes to complete the execution of the payment transaction to the intended payee (e.g., “River Electric”) to satisfy invoiced billing amount (e.g., “$120.48”). In accordance with the presently disclosed techniques, the account of the intended payee (e.g., “River Electric”) external to the payment service system 106 may be then transferred an amount of funds (e.g., “$120.48”) from an account of the payor 103a internal to the payment service system 106.

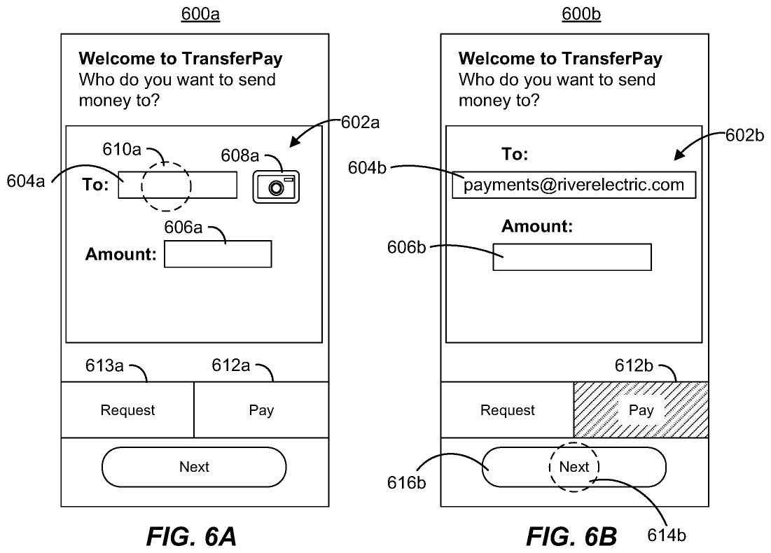

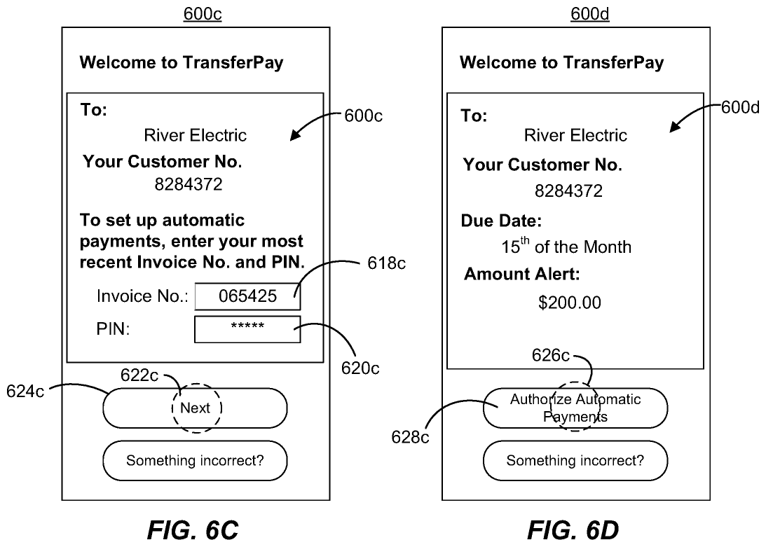

FIGS. 6A-6D illustrate one or more examples of user interfaces 600A, 600B, 600C, and 600D for identifying a payee type of an intended payee when the intended payee has an account external to a payment service, and further initiating and executing recurrent payment transactions to the intended payee, in accordance with presently disclosed embodiments. For example, and similar to example user interface 200a, example user interface 300a, example user interface 400a, and example user interface 500a, example user interface 600a includes a user interface 602a illustrating that a payor 103a wishes to execute a payment transaction. As depicted, the user interface 602a may include a text field 604a suitable for allowing the payor 103a to input an identifier to identify an intended payee, a text field 606a suitable for allowing the payor 103a to input a specified amount of funds (e.g., a currency value, an asset value) to be transferred to the intended payee, and an image-capture icon 608a that may be selected by the payor 103a to initiate, for example, an image capture of an identifier associated with an intended payee. As further depicted by FIG. 6A, the user interface 602a may also include one or more affordances 612a, 613a suitable for allowing the payor 103a to “Request” a payment of funds or “Pay” or send a payment of funds.

Referring to FIG. 6B, the example user interface 600b illustrates that the payor 103a may input into a text field 604b an identifier (e.g., “payments@riverelectric.com”) of an identifier corresponding to an intended payee having an account external to the payment service system 106. The payor 103a may then select an affordance 612b (e.g., “Pay”) indicating that the payor 103a wishes to send a payment and select by user input 614b an affordance 616b (e.g., “Next”) indicating that the payor 103a has completed inputting the identifier into the text field 604b. In some examples, in response to the payor 103a selecting the affordance 616b (e.g., “Next”), the example user interface 600c may be presented as depicted by FIG. 6C.

As depicted by FIG. 6C, the example user interface 600c illustrates that an intended payee (e.g., “River Electric”) may be identified based on the inputted identifier (e.g., “payments@riverelectric.com”) as having an account external to the payment service system 106. In some examples, upon the determining that the intended payee (e.g., “River Electric”) has an account external to the payment service system 106, the artificial intelligence component 118 may further determine that the payor 103a may establish recurring or automatic payments to the intended payee. The artificial intelligence component 118 may select, generate, or otherwise provide a transaction flow to facilitate authorization of these automatic payments. As further depicted by FIG. 6C, the example user interface 600c may include one or more prompts for the payor 103a to input into text fields 618c and 620c additional billing identification information such as, a biller code or invoice number “065425,” and additional personal identification such as, a PIN (e.g., “****”), a password, or biometric input. The example user interface 600c may also populate and display a customer reference number or account number (e.g., “8284372”) corresponding, for example, to a preestablished service account of the payor 103a with respect to the intended payee (e.g., “River Electric”).

The payor 103a may then select by user input 622c an affordance 624c (e.g., “Next”) indicating that the payor 103a has completed inputting the additional billing identification information (e.g., biller code or invoice number “065425”) into the text field 318c and the additional personal identification (e.g., PIN “****”). In some examples, in response to the payor 103a selecting the affordance 624c (e.g., “Next”), the example user interface 600d may be presented as depicted by FIG. 6D. As depicted by FIG. 6D, the example user interface 600d illustrates that a payment transaction between the payor 103a and the intended payee (e.g., “River Electric”) is to be executed in accordance with an invoiced billing amount (e.g., “$120.48”) for the current billing cycle and a billing amount (e.g., “$200.00”) to be paid for future billing cycles (e.g., on the 15^{th} of each calendar month).

The payor 103a may then select by user input 626d an affordance 628d (e.g., “Authorize Automatic Payments”) confirming that the payor 103a wishes to complete the execution of the payment transaction to the intended payee (e.g., “River Electric”) to satisfy the invoiced billing amount (e.g., “$120.48”) for the current billing cycle and to establish automatic payment transactions for future billing cycles (e.g., monthly billing cycles, bi-monthly billing cycles, or semi-annual billing cycles). In accordance with the presently disclosed techniques, the account of the intended payee (e.g., “River Electric”) external to the payment service system 106 may be then transferred an amount of funds (e.g., “$120.48”) from an account of the payor 103a internal to the payment service system 106. Further, future payment transactions of a specified amount of funds (e.g., “$200.00”) may be automatically transferred from an account of the payor 103a internal to the payment service system 106 to the account of the intended payee (e.g., “River Electric”) external to the payment service system 106 without soliciting any additional input from the payor 103a.

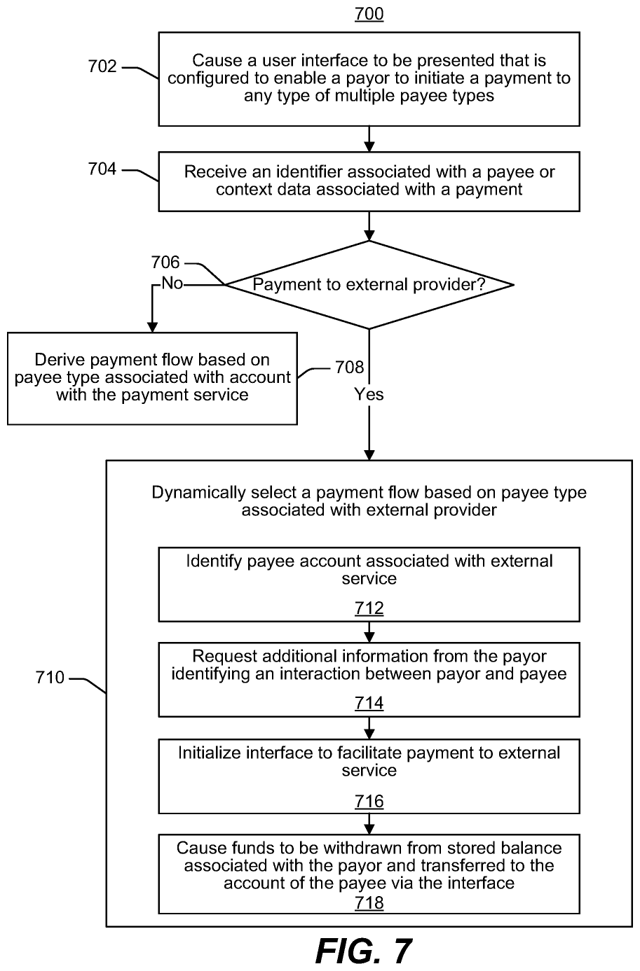

Particular embodiments may repeat one or more steps of the process of any of FIGS. 7-9, where appropriate. Although this disclosure describes and illustrates particular steps of the process of any of FIGS. 7-9 as occurring in a particular order, this disclosure contemplates any suitable steps of the process of any of FIGS. 7-9 occurring in any suitable order. Moreover, although this disclosure describes and illustrates an example method as described above, including the particular steps of the process of any of FIGS. 7-9, this disclosure contemplates any suitable method for performing the respective process, including any suitable steps, which may include all, some, or none of the steps of the process of any of FIGS. 7-9, where appropriate. Furthermore, although this disclosure describes and illustrates particular components, devices, or systems carrying out particular steps of the process of any of FIGS. 7-9, this disclosure contemplates any suitable combination of any suitable components, devices, or systems carrying out any suitable steps of the process of any of FIGS. 7-9.

The methods of any of FIGS. 7-9 may be performed utilizing one or more processing devices (e.g., processing devices or servers) that may include hardware (e.g., a general purpose processor, a graphic processing unit (GPU), an application-specific integrated circuit (ASIC), a system-on-chip (SoC), a microcontroller, a field-programmable gate array (FPGA), a central processing unit (CPU), an application processor (AP), a visual processing unit (VPU), a neural processing unit (NPU), a neural decision processor (NDP), or any other processing device(s) that may be suitable for processing transactions data, financial data, and user data), software (e.g., instructions running/executing on one or more processors), firmware (e.g., microcode), or some combination thereof.

FIG. 7 illustrates a flow diagram of a method 700 for dynamically selecting or generating a payment transaction flow based on an identified payee type for a payee, in accordance with presently disclosed embodiments. The method 700 may be performed utilizing one or more processing devices, such as the one or more servers 104 of the payment service system 106. The method 700 may begin at block 702 with the one or more servers 104 causing a user interface to be presented suitable for allowing a payor 103a to initiate a payment to any type of multiple payee types. For example, the user interface component 117 may cause a payment application executing on the user device 112a to display a user interface 102 including one or more text fields 110a and 110b for the payor 103a to initiate a retrieval of an intended payee and specify an amount for a payment transaction to the intended payee.

The method 700 may continue at block 704 with the one or more servers 104 receiving an identifier or context data associated with a payee. In one example, the user interface component 117 may receive the identifier input or context data input by the payor 103a and provide the identifier to an artificial intelligence component 118 or a search engine component 131. In one example, the search engine component 131 may include one or more search engines or rule-based algorithms that may be suitable for accessing and searching a database of known identifiers or context data 132 to identify the intended payee and determine a type of payee for the intended payee. In another example, as described herein, the artificial intelligence component 118 may include a combination of hardware and software artificial intelligence accelerators for executing one or more machine-learning models (e.g., one or more of a univariate logistic regression model, a multivariate logistic regression model, a random forest model, a Naïve Bayes model, a gradient boosting model, a neural network, and so forth) or other predictive models that may be suitable for predicting, based on an identifier associated with an intended payee or context data associated with an initiated payment, a payee type for the intended payee.

The method 700 may continue at decision 706 with the one or more servers 104 determining whether the intended payment is to, or involves, an external provider. For example, the one or more servers may determine whether the payee has an account external to the payment service system 106 or internal to the payment service system 106. In some examples, this determination can be based on context data, identifiers, combinations of the foregoing, and so on. In some examples, this determination can be done using artificial intelligence, as described above. In response to determining the payment is to an external provider, the method 700 may continue at block 708 with the one or more servers 104 deriving a payment flow based on a payee type associated with an account internal to the payment service. For example, the API management component 119 may access a database of payment transaction flow modules 134 and select, generate, or otherwise provide a payment transfer transaction flow in accordance with an identified intended payee that has an account internal to the payment service system 106. Upon completion of the payment transfer transaction flow, the transactions component 120 may then transfer a specified amount of funds from an account on the payment service system 106 associated with the payor 103a to an account on the payment service system 106 associated with the payee 103b.

In response to determining the intended payment is to, or involves, an external provider, the method 700 may continue at block 710 with the one or more servers 104 dynamically selecting a payment flow based on payee type associated with external provider. In one example, the API management component 119 may access the database of payment transaction flow modules 134 and select one of a number of predetermined payment transaction flows in accordance with the identified intended payee. In another example, the API management component 119 may access the database of payment transaction flow modules 134 and generate a customized payment transaction flow by deriving in real-time or near real-time a customized payment transaction flow in accordance with the identified intended payee.

In some examples, dynamically selecting a payment flow based on the payee type associated with the external provider may include one or more sub-blocks. At block 712 the one or more servers 104 may identify a payee account associated with the identified payee having an account external to the payment service system 106. The method 700 may continue at block 714 with the one or more servers 104 requesting additional information from the payor 103a identifying an interaction between the payor 103a and the intended payee. For example, the user interface component 117 may present a prompt for the payor 103a to input additional information, such as one or more of a biller code, a customer reference number, an account number, a PIN, an image, or a biometric identifier. The method 700 may continue at block 716 with the one or more servers 104 initializing an interface to facilitate a payment transaction between the payor 103a and the identified payee having an account external to the payment service system 106.

In some examples, the API management component 119 may be configured to automatically instantiate the one or more APIs 121 for exchanging transactions data and communications protocol data between the payment service system 106 and the one or more third-party servers 116 associated with the identified payee. The method 700 may then conclude at block 718 with the one or more servers 104 causing funds to be withdrawn from stored balance associated with the payor and transferred to the account of the payee via the user interface. In some examples, the transactions component 120 may proceed in executing a payment transaction by transferring the specified amount of funds from an account on the payment service system 106 associated with the payor 103a to the account external to the payment service system 106 associated with the identified intended payee in accordance with the one or more APIs 121.

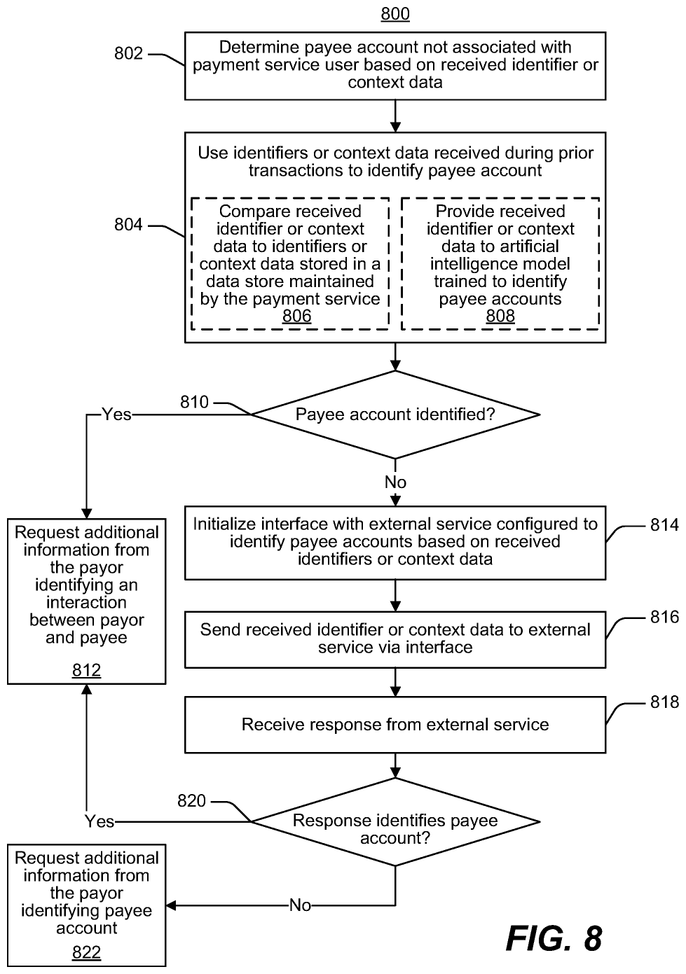

FIG. 8 illustrates a flow diagram of a method 800 for identifying a payee type an intended payee account when the intended payee has an account external to a payment service, in accordance with presently disclosed embodiments. The method 800 may be performed utilizing one or more processing devices, such as the one or more servers 104 of the payment service system 106. The method 800 may begin at block 802 with the one or more servers 104 determining that the intended payee account is not associated with a payment service user based on a received identifier or context associated with an intended payment transaction. For example, based on an identifier or context data or one or more chars indicative of an identifier associated with an intended payee being inputted into the text field 110a by the payor 103a, the user interface component 117 may provide an input to the search engine component 131 to generate a search of a database of known identifiers or context data 132 to identify a payee type for an intended payee or provide an input to the artificial intelligence component 118 to generate prediction of a payee type for an intended payee.

The method 800 may continue at block 804 with the one or more servers 104 utilizing one or more identifiers or context data received during prior transactions to identify an account of the intended payee. The one or more servers 104 may utilize one or more identifiers or context data received during prior transactions to identify an account of the intended payee by comparing at block 806 the received identifier to identifiers stored in a data store 128 maintained by the payment service system 106 or the received context data to context data stored in a data store 128 maintained by the payment service system 106. In some examples, the search engine component 131 may include one or more search engines or rule-based algorithms that may be suitable for accessing and searching a database of known identifiers or context data 132 to identify an intended payee and determine a type of payee for the intended payee.

The one or more servers 104 may additionally or alternatively utilize one or more identifiers or context data received during prior transactions to identify an account of the intended payee by providing at block 808 the received identifier or context data to an artificial intelligence component trained to identify a payee type and intended payee account. In some examples, the artificial intelligence component 118 may utilize one or more machine-learning models or other predictive models that may be suitable for predicting, based on the received identifier or context data associated with an intended payee, a payee type for the intended payee and an account of the intended payee.

The method 800 may continue at decision 810 with the one or more servers 104 determining whether an account of the intended payee has been identified, for example in block 804. In response to determining that an account of the intended payee has been identified, the method 800 may continue at block 812 with the one or more servers 104 requesting additional information from the payor 103a identifying an interaction between the payor 103a and the intended payee. For example, the user interface component 117 may present a prompt for the payor 103a to input additional information, such as one or more of a biller code, a customer reference number, or an account number. The interaction between the payor and payee may refer to goods sold to the payor by the payee, services rendered by the payee for the payor, other otherwise indicate that a payment is owed by the payor to the payee.

In response to determining that an account of the intended payee has not been identified, the method 800 may continue at block 814 with the one or more servers 104 initializing an interface with external service configured to identify payee accounts based on received identifiers or context data. In some examples, the API management component 119 may automatically instantiate one or more APIs 121 for exchanging transactions data and communications protocol data between the payment service system 106 and the one or more third-party servers 116 associated with the intended payee. The method 800 may continue at block 816 with the one or more servers 104 sending the received identifier or context data to an external service associated with the intended payee via the interface. For example, the API management component 119 may provide the received identifier to the one or more third-party servers 116 via the one or more APIs 121. The method 800 may continue at block 818 with the one or more servers 104 receiving a response from the external service associated with the intended payee via the interface. In one example, the API management component 119 may receive from the one or more third-party servers 116 an identity of the intended payee and the account of the intended payee. For example, the third-party servers 116 may be configured to provide requested identity information as part a response to a request using the APIs 121 to identify accounts or users of the external service.

The method 800 may continue at decision 820 with the one or more servers 104 determining whether the response identifies the intended payee and the account of the intended payee. In response to determining that the response identifies the intended payee and the account of the intended payee, the method 800 may continue at block 812 with the one or more servers 104 requesting additional information from the payor 103a identifying an interaction between the payor 103a and the intended payee. In response to determining that the response does not identify the intended payee and the account of the intended payee, the method 800 may conclude at block 822 with the one or more servers 104 requesting additional information from the payor 103a requesting identifying the payee account. In one example, the additional information may include an incorporated name of the intended payee, an email address of the intended payee, an internet protocol (IP) address of the intended payee, a physical address of the intended payee, a firmographic indicator associated with the intended payee, an account number associated with the intended payee, and so forth.

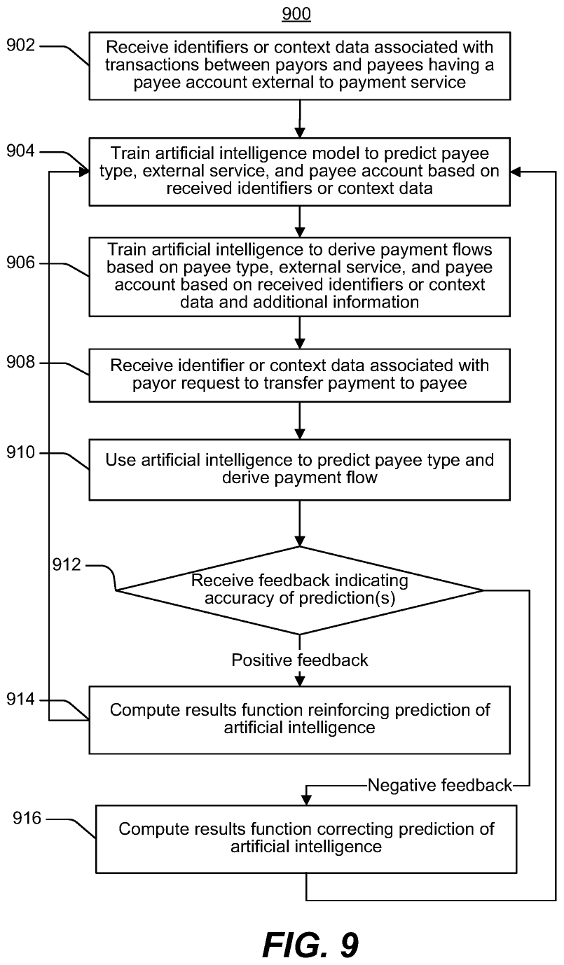

FIG. 9 illustrates a flow diagram of a method 900 for training an artificial intelligence model to predict payee type, external service, and payee account based on received identifiers or context data, in accordance with presently disclosed embodiments. The method 900 may be performed utilizing one or more processing devices, such as the one or more servers 104 of the payment service system 106. The method 900 may begin at block 902 with the one or more servers 104 receiving identifiers or context data associated with transactions between various payors 103a and payees having an account external to the payment service system 106. For example, the artificial intelligence component 118 may access a data set of identifiers or context data that may be stored to a database of known identifiers or context data 132.

In some examples, the database of known identifiers or context data 132 may include a relational database including a large data set of identifiers and context data associated with any of various types of payees and previous payment transactions as learned and stored overtime as, for example, different payors 103a execute payment transactions utilizing the payment service system 106.

For example, the database of known identifiers or context data 132 (e.g., relational database) may be suitable for associating and storing any of various identifiers (e.g., names, titles, categories, physical addresses, web addresses, phone numbers, email addresses, social media handles, digital signatures, image identifiers, tag identifiers, account numbers, IIINs, BIINs, logos, trademark symbols, stock trading tickers, text-based or image-based branding association indicators (e.g., advertising slogans, advertising jingles, advertising mascots, digital or physical advertisements, a specific color, and so forth), emojis, emoticons, geographical locations, or other similar features) or context data (e.g., amounts of previous payment transactions, dates of previous payment transactions, times of previous payment transactions, payment history of the payor 103a or one or more other payors 103a, various user interactions between payors 103a and associated web applications, entry points from which the payors 103a access the payment service application, one or more attachments associated with previous payment transactions, one or more text-based descriptors associated with previous payment transactions, or one or more image-based descriptors associated with previous payment transactions, and so forth) that may be utilized to train the artificial intelligence component 118 to predict a payee type of an intended payee by way of, for example, one or more of text classification, image classification, or object detection.

The method 900 may continue at block 904 with the one or more servers 104 training the artificial intelligence component 118 to predict a payee type, an intended payee, and an external account of the intended payee based on the received identifiers or context data. In some examples, the artificial intelligence component 118 may include one or more machine-learning or other predictive models that may be trained to predict, based on the received identifiers or context data, an identity of an intended payee, such as an external service provider, a payee type for the intended payee, and a type of the external service provider. The method 900 may continue at block 906 with the one or more servers 104 training the artificial intelligence component 118 to derive payment transaction flows based on the identity of an intended payee, such as an external service provider, a payee type for the intended payee, and the type of the external service provider.

In one example, based on a prediction by the artificial intelligence component 118 that the intended payee is a utility service provider or a telecommunications service provider, the API management component 119 may generate a payment transaction flow in which the user interface sequence includes one or more prompts for the payor 103a to input additional billing identification information such as, a biller code, a customer reference number, or an account number. In another example, based on a prediction by the artificial intelligence component 118 that the intended payee is a credit card issuer or an auto loan provider, the API management component 119 may select or generate a payment transaction flow in which the user interface sequence includes one or more prompts for the payor 103a to input additional billing identification information (e.g., a biller code, a customer reference number, an account number) and additional personal identification information (e.g., social security number, PIN, password) or personal identification inputs (e.g., face image, biometric input, two-factor authentication).

The method 900 may continue at block 908 with the one or more servers 104 receiving an identifier or context data associated with a request of the payor 103a to execute a payment transaction to an intended payee. The method 900 may continue at block 910 with the one or more servers 104 utilizing the artificial intelligence component 118 to predict a payee type of the intended payee and to derive payment transaction flow for the execution of the requested payment transaction. For example, as described herein, the artificial intelligence component 118 may predict that the intended payee is an external service provider and cause the API management component 119 to dynamically select or generate a customized payment transaction flow for the execution of the requested payment transaction. The method 900 may continue at decision 912 with the one or more servers 104 receiving feedback indicating an accuracy of the predictions performed by the artificial intelligence component 118.

If the received feedback is positive feedback, indicating that the prediction was accurate, the method 900 may continue at block 914 with the one or more servers 104 computing a results function for reinforcing predictions of the artificial intelligence component 118 in response to positive feedback. The results functions may be an instance of a reward function. If the received feedback is negative feedback, indicating that the prediction was not accurate, the method 900 may continue instead at block 916 with the one or more servers 104 computing a results function for correcting predictions of the artificial intelligence component 118 in response to negative feedback. The results function may be a loss function. For example, the artificial intelligence component 118 may include one or more reward models, which may be trained in accordance with a reinforcement learning (RL) training and/or fine-tuning process. In such an instance, the artificial intelligence component 118 may be “rewarded” for payment transactions executed and completed and “penalized” for payment transactions not executed and completed. From blocks 914 and 916, the method may continue to block 904, where the artificial intelligence model is re-trained based on the calculated results function. The artificial intelligence model may be continuously improved through the feedback loop represented by the method 900.

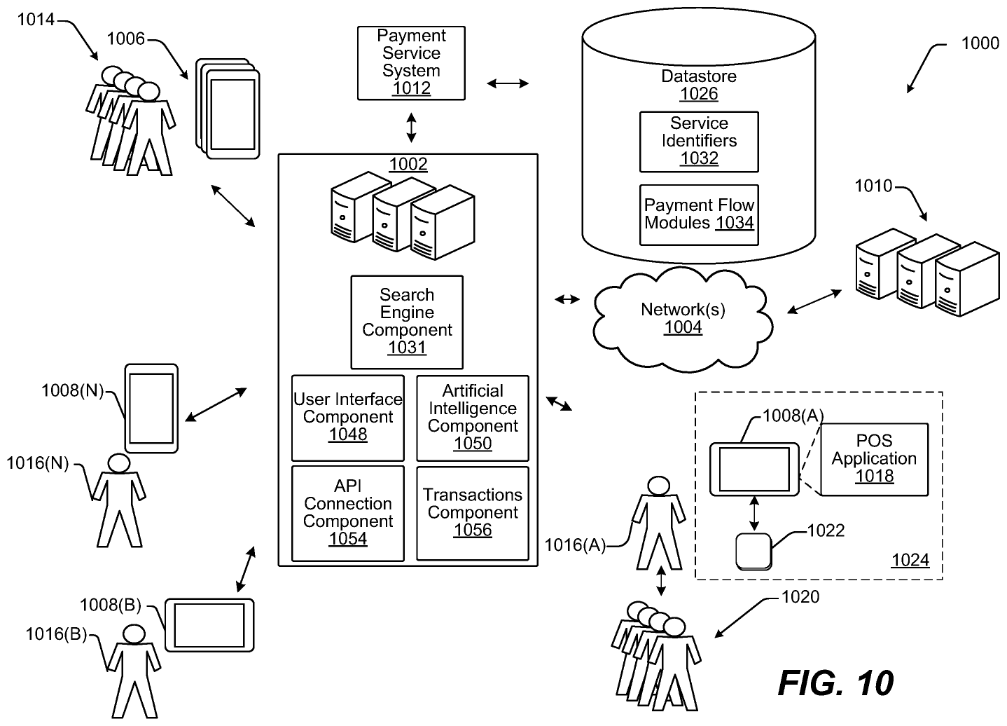

FIG. 10 illustrates an example environment 1000. The environment 1000 includes server(s) 1002 that can communicate over a network 1004 with user devices 1006 (which, in some examples may be merchant devices 1008 (individually, 1008(A)-1008(N))) and/or server(s) 1010 associated with third-party service provider(s). The server(s) 1002 may be associated with a service provider that can provide one or more services for the benefit of users 1014, as described below. Actions attributed to the service provider may be performed by the server(s) 1002.

Certain elements of environment 100 described with respect to FIG. 1 correspond to similar elements described herein with respect to FIG. 10. For example, the server(s) 1002 can correspond to server(s) 104, the network(s) 1004 can correspond to the network(s) 101, the user device(s) 1006 can correspond to the user device(s) 112, payment service system 1012 can correspond to payment service system 106 discussed in conjunction with FIG. 1, etc.

Similar to server(s) 104, servers 1002 can store one or more functional components that enable the payment service to perform operations as described herein. For example, the server(s) 1002 can store a user interface component 1048, an artificial intelligence component 1050, API connection component 1052, a search engine component 1031, and a transaction component 1054. Each component can function similarly to the respective components described in FIG. 1. In some examples, the payment service system 1012 can store one or more functional components that enable the payment service to perform operations as described herein.

The environment 1000 may include a plurality of user devices 1006, as described above. Each one of the plurality of user devices 1006 may be any type of computing device such as a tablet computing device, a smart phone or mobile communication device, a laptop, a netbook or other portable computer or semi-portable computer, a desktop computing device, a terminal computing device or other semi-stationary or stationary computing device, a dedicated device, a wearable computing device or other body-mounted computing device, an augmented reality device, a virtual reality device, an Internet of Things (IoT) device, etc. In some examples, individual ones of the user devices may be operable by users 1014. The users 1014 may be referred to as customers, buyers, merchants, sellers, borrowers, employees, employers, payors, payees, couriers and so on. The users 1014 can interact with the user devices 1006 via user interfaces presented via the user devices 1006.

In at least one example, a user interface may be presented via a web browser, or the like. In other examples, a user interface may be presented via an application, such as a mobile application or desktop application, which may be provided by the service provider or which may be an otherwise dedicated application. In some examples, individual of the user devices 1006 can have an instance or versioned instance of an application, which may be downloaded from an application store, for example, which can present the user interface(s) described herein. In at least one example, a user 1014 can interact with the user interface via touch input, spoken input, or any other type of input.

As described above, in at least one example, the users 1014 may include merchants 1016 (individually, 1016(A)-1016(N)). In an example, the merchants 1016 can operate respective merchant devices 1008, which may be user devices 1006 configured for use by merchants 1016. For the purpose of this discussion, a “merchant” may be any entity that offers items (e.g., goods or services) for purchase or other means of acquisition (e.g., rent, borrow, barter, etc.). The merchants 1016 can offer items for purchase or other means of acquisition via brick-and-mortar stores, mobile stores (e.g., pop-up shops, food trucks, etc.), online stores, combinations of the foregoing, and so forth. In some examples, at least some of the merchants 1016 may be associated with a same entity but can have different merchant locations and/or can have franchise/franchisee relationships. In additional or alternative examples, the merchants 1016 may be different merchants. That is, in at least one example, the merchant 1016(A) is a different merchant than the merchant 1016(B) and/or the merchant 1016(C).

For the purpose of this discussion, “different merchants” can refer to two or more unrelated merchants. “Different merchants” therefore can refer to two or more merchants that are different legal entities (e.g., natural persons and/or corporate persons) that do not share accounting, employees, branding, etc. “Different merchants,” as used herein, have different names, employer identification numbers (EIN)s, lines of business (in some examples), inventories (or at least portions thereof), and/or the like. Thus, the use of the term “different merchants” does not refer to a merchant with various merchant locations or franchise/franchisee relationships. Such merchants—with various merchant locations or franchise/franchisee relationships—may be referred to as merchants having different merchant locations and/or different commerce channels.

Each merchant device 1008 can have an instance of a POS application 1018 stored thereon. The POS application 1018 can configure the merchant device 1008 as a POS terminal, which enables the merchant 1016(A) to interact with one or more customers 1020. As described above, the users 1014 may include customers, such as the customers 1020 shown as interacting with the merchant 1016(A). For the purpose of this discussion, a “customer” may be any entity that acquires items from merchants. While only two customers 1020 are illustrated in FIG. 10, any number of customers 1020 can interact with the merchants 1016. Further, while FIG. 10 illustrates the customers 1020 interacting with the merchant 1016(A), the customers 1020 can interact with any of the merchants 1016.

In at least one example, interactions between the customers 1020 and the merchants 1016 that involve the exchange of funds (from the customers 1020) for items (from the merchants 1016) may be referred to as “transactions.” In at least one example, the POS application 1018 can determine transaction data associated with the POS transactions. Transaction data may include payment information, which may be obtained from a reader device 1022 associated with the merchant device 1008(A), user authentication data, purchase amount information, point-of-purchase information (e.g., item(s) purchased, date of purchase, time of purchase, etc.), etc. The POS application 1018 can send transaction data to the server(s) 1002 such that the server(s) 1002 can track transactions of the customers 1020, merchants 1016, and/or any of the users 1014 over time. Furthermore, the POS application 1018 can present a UI to enable the merchant 1016(A) to interact with the POS application 1018 and/or the service provider via the POS application 1018.

In at least one example, the merchant device 1008(A) may be a special-purpose computing device configured as a POS terminal (via the execution of the POS application 1018). In at least one example, the POS terminal may be connected to a reader device 1022, which is capable of accepting a variety of payment instruments, such as credit cards, debit cards, gift cards, short-range communication-based payment instruments, and the like, as described below. In at least one example, the reader device 1022 can plug in to a port in the merchant device 1008(A), such as a microphone port, a headphone port, an audio-jack, a data port, or other suitable port. In additional or alternative examples, the reader device 1022 may be coupled to the merchant device 1008(A) via another wired or wireless connection, such as via a Bluetooth®, BLE, and so on. Additional details are described below with reference to FIG. 10. In some examples, the reader device 1022 can read information from alternative payment instruments including, but not limited to, wristbands and the like.

In some examples, the reader device 1022 may physically interact with payment instruments such as magnetic stripe payment cards, EMV payment cards, and/or short-range communication (e.g., near field communication (NFC), radio frequency identification (RFID), Bluetooth®, Bluetooth® low energy (BLE), etc.) payment instruments (e.g., cards or devices configured for tapping). The POS terminal may provide a rich user interface, communicate with the reader device 1022, and communicate with the server(s) 1002, which can provide, among other services, a payment processing service. The server(s) 1002 associated with the service provider can communicate with server(s) 1010, as described below. In this manner, the POS terminal and reader device 1022 may collectively process transaction(s) between the merchants 1016 and customers 1020. In some examples, POS terminals and reader devices may be configured in one-to-one pairings. In other examples, the POS terminals and reader devices may be configured in many-to-one pairings (e.g., one POS terminal coupled to multiple reader devices or multiple POS terminals coupled to one reader device).

In some examples, there could be multiple POS terminal(s) connected to a number of other devices, such as “secondary” terminals, e.g., back-of-the-house systems, printers, line-buster devices, POS readers, and the like, to allow for information from the secondary terminal to be shared between the primary POS terminal(s) and secondary terminal(s), for example via short-range communication technology. This kind of arrangement may also work in an offline-online scenario to allow one device (e.g., secondary terminal) to continue taking user input, and synchronize data with another device (e.g., primary terminal) when the primary or secondary terminal switches to online mode. In other examples, such data synchronization may happen periodically or at randomly selected time intervals.

While the POS terminal and the reader device 1022 of the POS system 1024 are shown as separate devices, in additional or alternative examples, the POS terminal and the reader device 1022 may be part of a single device. In some examples, the reader device 1022 can have a display integrated therein for presenting information to the customers 1020. In additional or alternative examples, the POS terminal can have a display integrated therein for presenting information to the customers 1020. POS systems, such as the POS system 1024, may be mobile, such that POS terminals and reader devices may process transactions in disparate locations across the world. POS systems may be used for processing card-present transactions and card-not-present (CNP) transactions, as described below.

A card-present transaction is a transaction where both a customer 1020 and his or her payment instrument are physically present at the time of the transaction. Card-present transactions may be processed by swipes, dips, taps, or any other interaction between a physical payment instrument (e.g., a card), or otherwise present payment instrument, and a reader device 1022 whereby the reader device 1022 is able to obtain payment data from the payment instrument. A swipe is a card-present transaction where a customer 1020 slides a card, or other payment instrument, having a magnetic strip through a reader device 1022 that captures payment data contained in the magnetic strip. A dip is a card-present transaction where a customer 1020 inserts a payment instrument having an embedded microchip (i.e., chip) into a reader device 1022 first. The dipped payment instrument remains in the payment reader until the reader device 1022 prompts the customer 1020 to remove the card, or other payment instrument.

While the payment instrument is in the reader device 1022, the microchip can create a one-time code which is sent from the POS system 1024 to the server(s) 1010 (which may be associated with third-party service providers that provide payment services, including but not limited to, an acquirer bank, an issuer, and/or a card payment network (e.g., Mastercard®, VISA®, etc.)) to be matched with an identical one-time code. A tap is a card-present transaction where a customer 1020 may tap or hover his or her payment instrument (e.g., card, user device such as a smart phone running a payment service application, etc.) over a reader device 1022 to complete a transaction via short-range communication (e.g., NFC, RFID, Bluetooth®, BLE, etc.). Short-range communication enables the payment instrument to exchange information with the reader device 1022. A tap may also be called a contactless payment.

A CNP transaction is a transaction where a card, or other payment instrument, is not physically present at the POS such that payment data is required to be manually keyed in (e.g., by a merchant, customer, etc.), or payment data is required to be recalled from a card-on-file data store, to complete the transaction.

The POS system 1024, the server(s) 1002, and/or the server(s) 1010 may exchange payment information and transaction data to determine whether transactions are authorized. For example, the POS system 1024 may provide encrypted payment data, user authentication data, purchase amount information, point-of-purchase information, etc. (collectively, transaction data) to server(s) 1002 over the network(s) 1004. The server(s) 1002 may send the transaction data to the server(s) 1010. As described above, in at least one example, the server(s) 1010 may be associated with third-party service providers that provide payment services, including but not limited to, an acquirer bank, an issuer, and/or a card payment network (e.g., Mastercard®, VISA®, etc.)

For the purpose of this discussion, the “payment service providers” may be acquiring banks (“acquirer”), issuing banks (“issuer”), card payment networks, and the like. In an example, an acquirer is a bank or financial institution that processes payments (e.g., credit or debit card payments) and can assume risk on behalf of merchants(s). An acquirer may be a registered member of a card association (e.g., Visa®, MasterCard®), and may be part of a card payment network. The acquirer (e.g., the server(s) 1010 associated therewith) can send a fund transfer request to a server computing device of a card payment network (e.g., Mastercard®, VISA®, etc.) to determine whether the transaction is authorized or deficient. In at least one example, the service provider can serve as an acquirer and connect directly with the card payment network.

The card payment network (e.g., the server(s) 1010 associated therewith) can forward the fund transfer request to an issuing bank (e.g., “issuer”). The issuer is a bank or financial institution that offers a financial account (e.g., credit or debit card account) to a user. An issuer can issue payment cards to users and can pay acquirers for purchases made by cardholders to which the issuing bank has issued a payment card. The issuer (e.g., the server(s) 1010 associated therewith) can make a determination as to whether the customer has the capacity to absorb the relevant charge associated with the payment transaction. In at least one example, the service provider can serve as an issuer and/or can partner with an issuer. The transaction is either approved or rejected by the issuer and/or the card payment network (e.g., the server(s) 1010 associated therewith), and a payment authorization message is communicated from the issuer to the POS device via a path opposite of that described above, or via an alternate path.

The payment service 1012 can access a datastore 1026 (e.g., datastore 128) to access data regarding one or more restricted balances 132 or unrestricted balances 134 associated with restricted accounts or unrestricted accounts, respectively, of one or more user.

As described above, the server(s) 1010, which may be associated with payment service provider(s), may determine whether the transaction is authorized based on the transaction data, as well as information relating to parties to the transaction (e.g., the customer 1020 and/or the merchant 1016(A)). The server(s) 1010 may send an authorization notification over the network(s) 1004 to the server(s) 1002, which may send the authorization notification to the POS system 1024 over the network(s) 1004 to indicate whether the transaction is authorized. The server(s) 1002 may also transmit additional information such as transaction identifiers to the POS system 1024. In one example, the server(s) 1002 may include a merchant application and/or other functional components for communicating with the POS system 1024 and/or the server(s) 1010 to authorize or decline transactions.

Based on the authentication notification that is received by the POS system 1024 from server(s) 1002, the merchant 1016(A) may indicate to the customer 1020 whether the transaction has been approved. In some examples, approval may be indicated at the POS system 1024, for example, at a display of the POS system 1024. In other examples, such as with a smart phone or watch operating as a short-range communication payment instrument, information about the approved transaction may be provided to the short-range communication payment instrument for presentation via a display of the smart phone or watch. In some examples, additional or alternative information can additionally be presented with the approved transaction notification including, but not limited to, receipts, special offers, coupons, or loyalty program information.

As mentioned above, the service provider can provide, among other services, payment processing services, inventory management services, catalog management services, business banking services, financing services, lending services, reservation management services, web-development services, payroll services, employee management services, appointment services, loyalty tracking services, restaurant management services, order management services, fulfillment services, onboarding services, identity verification (IDV) services, and so on. In some examples, the users 1014 can access all of the services of the service provider. In other examples, the users 1014 can have gradated access to the services, which may be based on risk tolerance, IDV outputs, subscriptions, and so on. In at least one example, access to such services may be availed to the merchants 1016 via the POS application 1018. In additional or alternative examples, each service may be associated with its own access point (e.g., application, web browser, etc.).

The service provider can offer payment processing services for processing payments on behalf of the merchants 1016, as described above. For example, the service provider can provision payment processing software, payment processing hardware and/or payment processing services to merchants 1016, as described above, to enable the merchants 1016 to receive payments from the customers 1020 when conducting POS transactions with the customers 1020. For instance, the service provider can enable the merchants 1016 to receive cash payments, payment card payments, and/or electronic payments from customers 1020 for POS transactions and the service provider can process transactions on behalf of the merchants 1016.

As the service provider processes transactions on behalf of the merchants 1016, the service provider can maintain accounts or balances for the merchants 1016 in one or more ledgers. For example, the service provider can analyze transaction data received for a transaction to determine an amount of funds owed to a merchant 1016(A) for the transaction. In at least one example, such an amount may be a total purchase price less fees charged by the service provider for providing the payment processing services. Based on determining the amount of funds owed to the merchant 1016(A), the service provider can deposit funds into an account of the merchant 1016(A). The account can have a stored balance, which may be managed by the service provider. The account may be different from a conventional bank account at least because the stored balance is managed by a ledger of the service provider and the associated funds are accessible via various withdrawal channels including, but not limited to, scheduled deposit, same-day deposit, instant deposit, and a linked payment instrument.

A scheduled deposit can occur when the service provider transfers funds associated with a stored balance of the merchant 1016(A) to a bank account of the merchant 1016(A) that is held at a bank or other financial institution (e.g., associated with the server(s) 1010). Scheduled deposits can occur at a prearranged time after a POS transaction is funded, which may be a business day after the POS transaction occurred, or sooner or later. In some examples, the merchant 1016(A) can access funds prior to a scheduled deposit. For instance, the merchant 1016(A) may have access to same-day deposits (e.g., wherein the service provider deposits funds from the stored balance to a linked bank account of the merchant on a same day as POS transaction, in some examples prior to the POS transaction being funded) or instant deposits (e.g., wherein the service provider deposits funds from the stored balance to a linked bank account of the merchant on demand, such as responsive to a request). Further, in at least one example, the merchant 1016(A) can have a payment instrument that is linked to the stored balance that enables the merchant to access the funds without first transferring the funds from the account managed by the service provider to the bank account of the merchant 1016(A).

In at least one example, the service provider may provide inventory management services. That is, the service provider may provide inventory tracking and reporting. Inventory management services may enable the merchant 1016(A) to access and manage a database storing data associated with a quantity of each item that the merchant 1016(A) has available (i.e., an inventory). Furthermore, in at least one example, the service provider can provide catalog management services to enable the merchant 1016(A) to maintain a catalog, which may be a database storing data associated with items that the merchant 1016(A) has available for acquisition (i.e., catalog management services). In at least one example, the catalog may include a plurality of data items and a data item of the plurality of data items may represent an item that the merchant 1016(A) has available for acquisition. The service provider can offer recommendations related to pricing of the items, placement of items on the catalog, and multi-party fulfillment of the inventory.

In at least one example, the service provider can provide business banking services, which allow the merchant 1016(A) to track deposits (from payment processing and/or other sources of funds) into an account of the merchant 1016(A), payroll payments from the account (e.g., payments to employees of the merchant 1016(A)), payments to other merchants (e.g., business-to-business) directly from the account or from a linked debit card, withdrawals made via scheduled deposit and/or instant deposit, etc. Furthermore, the business banking services can enable the merchant 1016(A) to obtain a customized payment instrument (e.g., credit card), check how much money they are earning (e.g., via presentation of available earned balance), understand where their money is going (e.g., via deposit reports (which may include a breakdown of fees), spend reports, etc.), access/use earned money (e.g., via scheduled deposit, instant deposit, linked payment instrument, etc.), feel in control of their money (e.g., via management of deposit schedule, deposit speed, linked instruments, etc.), etc. Moreover, the business banking services can enable the merchants 1016 to visualize their cash flow to track their financial health, set aside money for upcoming obligations (e.g., savings), organize money around goals, etc.

In at least one example, the service provider can provide financing services and products, such as via business loans, consumer loans, fixed term loans, flexible term loans, and the like. In at least one example, the service provider can utilize one or more risk signals to determine whether to extend financing offers and/or terms associated with such financing offers.

In at least one example, the service provider can provide financing services for offering and/or lending a loan to a borrower that is to be used for, in some instances, financing the borrower's short-term operational needs (e.g., a capital loan). For instance, a potential borrower that is a merchant can obtain a capital loan via a capital loan product in order to finance various operational costs (e.g., rent, payroll, inventory, etc.). In at least one example, the service provider can offer different types of capital loan products. For instance, in at least one example, the service provider can offer a daily repayment loan product, wherein a capital loan is repaid daily, for instance, from a portion of transactions processed by the payment processing service on behalf of the borrower. Additionally, and/or alternatively, the service provider can offer a monthly repayment loan product, wherein a capital loan is repaid monthly, for instance, via a debit from a bank account linked to the payment processing service. The credit risk of the merchant may be evaluated using risk models that take into account factors, such as payment volume, credit risk of similarly situated merchants, past transaction history, seasonality, credit history, and so on.

Additionally, or alternatively, the service provider can provide financing services for offering and/or lending a loan to a borrower that is to be used for, in some instances, financing the borrower's consumer purchase (e.g., a consumer loan). In at least one example, a borrower can submit a request for a loan to enable the borrower to purchase an item from a merchant, which may be one of the merchants 1016. The service provider can generate the loan based at least in part on determining that the borrower purchased or intends to purchase the item from the merchant. The loan may be associated with a balance based on an actual purchase price of the item and the borrower can repay the loan over time.

In some examples, the borrower can repay the loan via installments, which may be paid via funds managed and/or maintained by the service provider (e.g., from payments owed to the merchant from payments processed on behalf of the merchant, funds transferred to the merchant, etc.). The service provider can offer specific financial products, such as payment instruments, tied specifically to the loan products. For example, in one implementation, the server provider 1012 associates capital to a merchant or customer's debit card, where the use of the debit card is defined by the terms of the loan. In some examples, the merchant may only use the debit card for making specific purchases. In other examples, the “installment” associated with the loan product is credited directly via the payment instrument. The payment instrument is thus customized to the loan and/or the parties associated with the loan.

The service provider can provide web-development services, which enable users 1014 who are unfamiliar with HTML, XML, JavaScript, CSS, or other web design tools to create and maintain professional and aesthetically pleasing websites. Some of these web page editing applications allow users to build a web page and/or modify a web page (e.g., change, add, or remove content associated with a web page). Further, in addition to websites, the web-development services can create and maintain other online omni-channel presences, such as social media posts for example. In some examples, the resulting web page(s) and/or other content items may be used for offering item(s) for sale via an online/e-commerce platform. That is, the resulting web page(s) and/or other content items may be associated with an online store or offering by the one or more of the merchants 1016. In at least one example, the service provider can recommend and/or generate content items to supplement omni-channel presences of the merchants 1016. That is, if a merchant of the merchants 1016 has a web page, the service provider-via the web-development or other services—can recommend and/or generate additional content items to be presented via other channel(s), such as social media, email, etc.

Furthermore, the service provider can provide payroll services to enable employers to pay employees for work performed on behalf of employers. In at least one example, the service provider can receive data that includes time worked by an employee (e.g., through imported timecards and/or POS interactions), sales made by the employee, gratuities received by the employee, and so forth. Based on such data, the service provider can make payroll payments to employee(s) on behalf of an employer via the payroll service. For instance, the service provider can facilitate the transfer of a total amount to be paid out for the payroll of an employee from the bank of the employer to the bank of the service provider to be used to make payroll payments. In at least one example, when the funds have been received at the bank of the service provider, the service provider can pay the employee, such as by check or direct deposit, often a day, a week, or more after when the work was actually performed by the employee. In additional or alternative examples, the service provider can enable employee(s) to receive payments via same-day or instant deposit based at least in part on risk and/or reliability analyses performed by the service provider.

Moreover, in at least one example, the service provider can provide employee management services for managing schedules of employees. Further, the service provider can provide appointment services for enabling users 1014 to set schedules for scheduling appointments and/or users 1014 to schedule appointments.

In some examples, the service provider can provide restaurant management services to enable users 1014 to make and/or manage reservations, to monitor front-of-house and/or back-of-house operations, and so on. In such examples, the merchant device(s) 1008 and/or server(s) 1002 may be configured to communicate with one or more other computing devices, which may be located in the front-of-house (e.g., POS device(s)) and/or back-of-house (e.g., kitchen display system(s) (KDS)). In at least one example, the service provider can provide order management services and/or fulfillment services to enable restaurants to manage open tickets, split tickets, and so on and/or manage fulfillment services. In some examples, such services may be associated with restaurant merchants, as described above. In additional or alternative examples, such services may be any type of merchant.

In at least one example, the service provider can provide fulfilment services, which can use couriers for delivery, wherein couriers can travel between multiple locations to provide delivery services, photography services, etc. Couriers may be users 1014 who can travel between locations to perform services for a requesting user 1014 (e.g., deliver items, capture images, etc.). In some examples, the courier can receive compensation from the service provider. The courier can employ one or more vehicles, such as automobiles, bicycles, scooters, motorcycles, buses, airplanes, helicopters, boats, skateboards, etc. Although, in other instances the courier can travel by foot or otherwise without a vehicle. Some examples discussed herein enable people to participate as couriers in a type of crowdsourced service economy.

Here, essentially any person with a mobile device is able to immediately become a courier, or cease to be a courier, in a courier network that provides services as described herein. In at least one example, the couriers may be unmanned aerial vehicles (e.g., drones), autonomous vehicles, or any other type of vehicle capable of receiving instructions for traveling between locations. In some examples, the service provider can receive requests for courier services, automatically assign the requests to active couriers, and communicate dispatch instructions to couriers via user interface (e.g., application, web browser, or other access point) presented via respective devices 1006.

In some examples, the service provider can provide omni-channel fulfillment services. For instance, if a customer places an order with a merchant and the merchant cannot fulfill the order because one or more items are out of stock or otherwise unavailable, the service provider can leverage other merchants and/or sales channels that are part of the platform of the service provider to fulfill the customer's order. That is, another merchant can provide the one or more items to fulfill the order of the customer. Furthermore, in some examples, another sales channel (e.g., online, brick-and-mortar, etc.) may be used to fulfill the order of the customer.

In some examples, the service provider can enable conversational commerce via conversational commerce services, which can use one or more machine learning mechanisms to analyze messages exchanged between two or more users 1014, voice inputs into a virtual assistant or the like, to determine intents of user(s) 1014. In some examples, the service provider can utilize determined intents to automate customer service, offer promotions, provide recommendations, or otherwise interact with customers in real-time. In at least one example, the service provider can integrate products and services, and payment mechanisms into a communication platform (e.g., messaging, etc.) to enable customers to make purchases, or otherwise transact, without having to call, email, or visit a web page or other channel of a merchant. That is, conversational commerce alleviates the need for customers to toggle back and forth between conversations and web pages to gather information and make purchases.

In at least one example, a user 1014 may be new to the service provider such that the user 1014 that has not registered (e.g., subscribed to receive access to one or more services offered by the service provider) with the service provider. The service provider can offer onboarding services for registering a potential user 1014 with the service provider. In some examples, onboarding can involve presenting various questions, prompts, and the like to a potential user 1014 to obtain information that may be used to generate a profile for the potential user 1014. In at least one example, the service provider can provide limited or short-term access to its services prior to, or during, onboarding (e.g., a user of a peer-to-peer payment service can transfer and/or receive funds prior to being fully onboarded, a merchant can process payments prior to being fully onboarded, etc.). In at least one example, responsive to the potential user 1014 providing all necessary information, the potential user 1014 may be onboarded to the service provider. In such an example, any limited or short-term access to services of the service provider may be transitioned to more permissive (e.g., less limited) or longer-term access to such services.

The service provider may be associated with IDV services, which may be used by the service provider for compliance purposes and/or may be offered as a service, for instance to third-party service providers (e.g., associated with the server(s) 1010). That is, the service provider can offer IDV services to verify the identity of users 1014 seeking to use or using their services. Identity verification requests a customer (or potential customer) to provide information that is used by compliance departments to prove that the information is associated with an identity of a real person or entity. In at least one example, the service provider can perform services for determining whether identifying information provided by a user 1014 accurately identifies the customer (or potential customer) (i.e., Is the customer who they say they are?).

The service provider is capable of providing additional or alternative services and the services described above are offered as a sampling of services. In at least one example, the service provider can exchange data with the server(s) 1010 associated with third-party service providers. Such third-party service providers can provide information that enables the service provider to provide services, such as those described above. In additional or alternative examples, such third-party service providers can access services of the service provider. That is, in some examples, the third-party service providers may be subscribers, or otherwise access, services of the service provider.

Techniques described herein may be configured to operate in both real-time/online and offline modes. “Online” modes refer to modes when devices are capable of communicating with the service provider (e.g., the server(s) 1002) and/or the server(s) 1010 via the network(s) 1004. In some examples, the merchant device(s) 1008 are not capable of connecting with the service provider (e.g., the server(s) 1002) and/or the server(s) 1010, due to a network connectivity issue, for example. In additional or alternative examples, the server(s) 1002 are not capable of communicating with the server(s) 1010 due to network connectivity issue, for example. In such examples, devices may operate in “offline” mode where at least some payment data is stored (e.g., on the merchant device(s) 1008) and/or the server(s) 1002 until connectivity is restored and the payment data may be transmitted to the server(s) 1002 and/or the server(s) 1010 for processing.

In at least one example, the service provider may be associated with a hub, such as an order hub, an inventory hub, a fulfillment hub and so on, which can enable integration with one or more additional service providers (e.g., associated with the additional server(s) 1010). In some examples, such additional service providers can offer additional or alternative services and the service provider can provide an interface or other computer-readable instructions to integrate functionality of the service provider into the one or more additional service providers.

Techniques described herein are directed to services provided via a distributed system of user devices 1006 that are in communication with server(s) 1002 of the service provider. That is, techniques described herein are directed to a specific implementation—or, a practical application—of utilizing a distributed system of user devices 1006 that are in communication with server(s) 1002 of the service provider to perform a variety of services, as described above. The unconventional configuration of the distributed system described herein enables the server(s) 1002 that are remotely located from end-users (e.g., users 1014) to intelligently offer services based on aggregated data associated with the end-users, such as the users 1014 (e.g., data associated with multiple, different merchants and/or multiple, different buyers), in some examples, in near-real time.

Accordingly, techniques described herein are directed to a particular arrangement of elements that offer technical improvements over conventional techniques for performing payment processing services and the like. For small business owners in particular, the business environment is typically fragmented and relies on unrelated tools and programs, making it difficult for an owner to manually consolidate and view such data. The techniques described herein constantly or periodically monitor disparate and distinct merchant accounts, e.g., accounts within the control of the service provider, and those outside of the control of the service provider, to track the business standing (payables, receivables, payroll, invoices, appointments, capital, etc.) of the merchants. The techniques herein provide a consolidated view of a merchant's cash flow, predict needs, preemptively offer recommendations or services, such as capital, coupons, etc., and/or enable money movement between disparate accounts (merchant's, another merchant's, or even payment service's) in a frictionless and transparent manner.

As described herein, artificial intelligence, machine learning, and the like may be used to dynamically make determinations, recommendations, and the like, thereby adding intelligence and context-awareness to an otherwise one-size-fits-all scheme for providing payment processing services and/or additional or alternative services described herein. In some implementations, the distributed system is capable of applying the intelligence derived from an existing user base to a new user, thereby making the onboarding experience for the new user personalized and frictionless when compared to traditional onboarding methods. Thus, techniques described herein improve existing technological processes.

As described above, various graphical user interfaces (GUIs) may be presented to facilitate techniques described herein. Some of the techniques described herein are directed to user interface features presented via GUIs to improve interaction between users 1014 and user devices 1006. Furthermore, such features are changed dynamically based on the profiles of the users involved interacting with the GUIs. As such, techniques described herein are directed to improvements to computing systems.

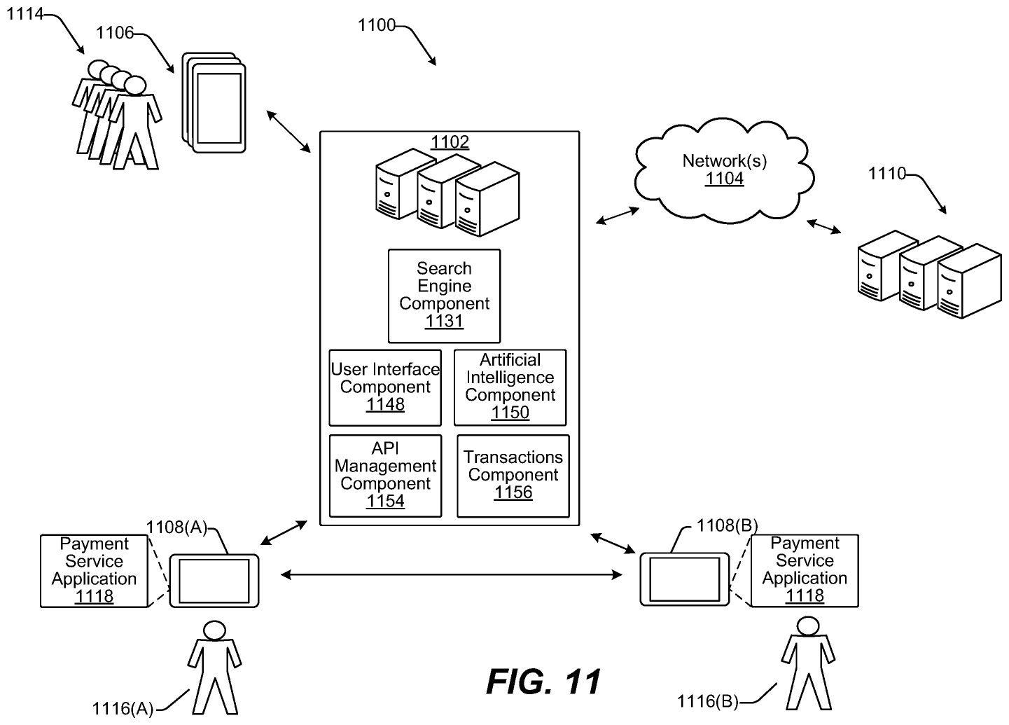

FIG. 11 illustrates an example environment 1100. The environment 1100 includes server(s) 1102 that can communicate over a network 1104 with user devices 1106 (which, in some examples may be user devices 1108 (individually, 1108(A), 1108(B)) and/or server(s) 1110 associated with third-party service provider(s). The server(s) 1102 may be associated with a service provider that can provide one or more services for the benefit of users 1114, as described below. Actions attributed to the service provider may be performed by the server(s) 1102. In some examples, the service provider referenced in FIG. 10 may be the same or different than the service provider referenced in FIG. 11.

Certain elements of environment 100 described with respect to FIG. 1 correspond to similar elements described herein with respect to FIG. 11. For example, the server(s) 1102 can correspond to server(s) 104, the network(s) 1104 can correspond to the network(s) 101, the user device(s) 1106 can correspond to the user device(s) 112, discussed in conjunction with FIG. 1, etc.

Similar to server(s) 104, servers 1102 can store one or more functional components that enable the payment service to perform operations as described herein. For example, the server(s) 1102 can store a user interface component 1148, an artificial intelligence component 1150, API connection component 1152, a search engine component 1131, and a transaction component 1154. Each component can function similarly to the respective components described in FIG. 1. The servers 1102 can access a datastore 826 (e.g., datastore 128) to access data regarding one or more restricted balances 132 or unrestricted balances 134 associated with restricted accounts or unrestricted accounts, respectively, of one or more user.

The environment 1100 may include a plurality of user devices 1106, as described above. Each one of the plurality of user devices 1106 may be any type of computing device such as a tablet computing device, a smart phone or mobile communication device, a laptop, a netbook or other portable computer or semi-portable computer, a desktop computing device, a terminal computing device or other semi-stationary or stationary computing device, a dedicated device, a wearable computing device or other body-mounted computing device, an augmented reality device, a virtual reality device, an Internet of Things (IoT) device, etc. In some examples, individual ones of the user devices may be operable by users 1114. The users 1114 may be referred to as customers, buyers, merchants, sellers, borrowers, employees, employers, payors, payees, couriers and so on.

The users 1114 can interact with the user devices 1106 via user interfaces presented via the user devices 1106. In at least one example, a user interface may be presented via a web browser, or the like. In other examples, a user interface may be presented via an application, such as a mobile application or desktop application, which may be provided by the service provider or which may be an otherwise dedicated application. In some examples, individual of the user devices 1106 can have an instance or versioned instance of an application, which may be downloaded from an application store, for example, which can present the user interface(s) described herein. In at least one example, a user 1114 can interact with the user interface via touch input, spoken input, or any other type of input.

In at least one example, the service provider can provide a peer-to-peer payment service that enables peer-to-peer payments between two or more users 1114. Two users, user 1116(A) and user 1116(B) are illustrated in FIG. 11 as “peers” in a peer-to-peer payment. In at least one example, the service provider can communicate with instances of a payment service application 1118 (or other access point) installed on devices 1106 configured for operation by users 1114. In an example, an instance of the payment service application 1118 executing on a first device 1108(A) operated by a payor (e.g., user 1116(A)) can send a request to the service provider to transfer an asset (e.g., fiat currency, non-fiat currency, digital assets, cryptocurrency, securities, gift cards, and/or related assets) from the payor to a payee (e.g., user 1116(B)) via a peer-to-peer payment. In some examples, assets associated with an account of the payor are transferred to an account of the payee. In some examples, assets may be held at least temporarily in an account of the service provider prior to transferring the assets to the account of the payee.

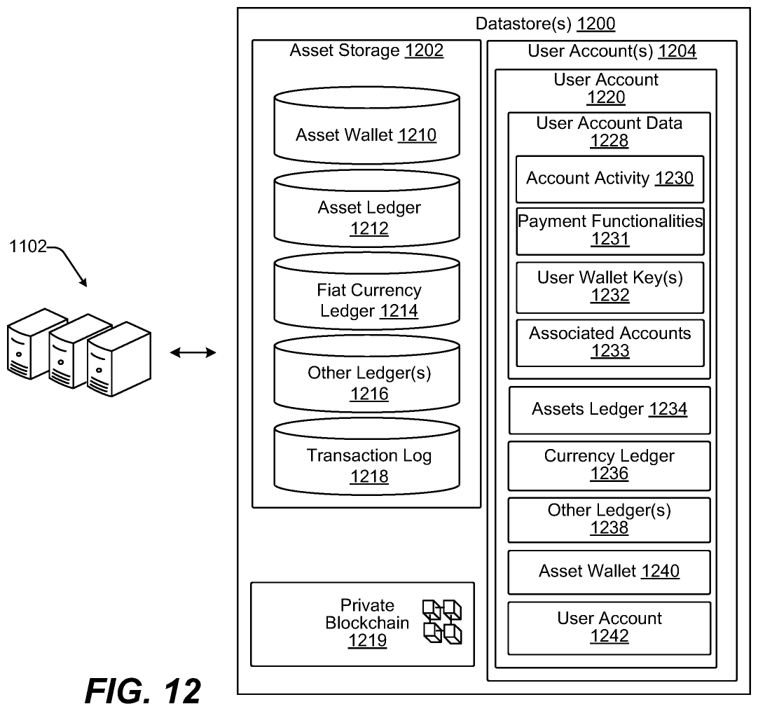

In some examples, the service provider can utilize a ledger system to track transfers of assets between users 1114. FIG. 12, below, provides additional details associated with such a ledger system. The ledger system can enable users 1114 to own fractional shares of assets that are not conventionally available. For instance, a user can own a fraction of a Bitcoin or a stock. Additional details are described herein.

In at least one example, the service provider can facilitate transfers and can send notifications related thereto to instances of the payment service application 1118 executing on user device(s) of payee(s). As an example, the service provider can transfer assets from an account of user 1116(A) to an account of the user 1116(B) and can send a notification to the user device 1108(B) of the user 1116(B) for presentation via a user interface. The notification can indicate that a transfer is in process, a transfer is complete, or the like. In some examples, the service provider can send additional or alternative information to the instances of the payment service application 1118 (e.g., low balance to the payor, current balance to the payor or the payee, etc.). In some examples, the payor and/or payee may be identified automatically, e.g., based on context, proximity, prior transaction history, and so on. In other examples, the payee can send a request for funds to the payor prior to the payor initiating the transfer of funds. In some examples, the service provider funds the request to payee on behalf of the payor, to speed up the transfer process and compensate for any lags that may be attributed to the payor's financial network.

In some examples, the service provider can trigger the peer-to-peer payment process through identification of a “payment proxy” having a particular syntax. For example, the syntax may include a monetary currency indicator prefixing one or more alphanumeric characters (e.g., $Cash). The currency indicator operates as the tagging mechanism that indicates to the server(s) 1102 to treat the inputs as a request from the payor to transfer assets, where detection of the syntax triggers a transfer of assets. The currency indicator can correspond to various currencies including but not limited to, dollar ($), euro (€), pound (£), rupee ( [symbol] ), yuan (V), etc. Although use of the dollar currency indicator ($) is used herein, it is to be understood that any currency symbol could equally be used. In some examples, additional or alternative identifiers may be used to trigger the peer-to-peer payment process. For instance, email, telephone number, social media handles, and/or the like may be used to trigger and/or identify users of a peer-to-peer payment process.

In some examples, the peer-to-peer payment process may be initiated through instances of the payment service application 1118 executing on the user devices 1106. In at least some examples, the peer-to-peer process may be implemented within a landing page associated with a user and/or an identifier of a user. The term “landing page,” as used here, refers to a virtual location identified by a personalized location address that is dedicated to collect payments on behalf of a recipient associated with the personalized location address. The personalized location address that identifies the landing page may include a payment proxy discussed above. The service provider can generate the landing page to enable the recipient to conveniently receive one or more payments from one or more senders. In some examples, the personalized location address identifying the landing page may be a uniform resource locator (URL) that incorporates the payment proxy. In such examples, the landing page may be a web page, e.g., www.cash.me/$Cash.

In some examples, the peer-to-peer payment process may be implemented within a forum. The term “forum,” as used here, refers to a content provider's media channel (e.g., a social networking platform, a microblog, a blog, video sharing platform, a music sharing platform, etc.) that enables user interaction and engagement through comments, posts, messages on electronic bulletin boards, messages on a social networking platform, and/or any other types of messages. In some examples, the content provider may be the service provider as described with reference to FIG. 11 or a third-party service provider associated with the server(s) 1110. In examples where the content provider is a third-party service provider, the server(s) 1110 may be accessible via one or more APIs or other integrations.

The forum may be employed by a content provider to enable users of the forum to interact with one another (e.g., through creating messages, posting comments, etc.). In some examples, “forum” may also refer to an application or webpage of an e-commerce or retail organization that offers products and/or services. Such websites can provide an online “form” to complete before or after the products or services are added to a virtual cart. The online form may include one or more fields to receive user interaction and engagement. Examples include name and other identification of the user, shipping address of the user, etc. Some of these fields may be configured to receive payment information, such as a payment proxy, in lieu of other kinds of payment mechanisms, such as credit cards, debit cards, prepaid cards, gift cards, virtual wallets, etc.

In some examples, the peer-to-peer process may be implemented within a communication application, such as a messaging application. The term “messaging application,” as used here, refers to any messaging application that enables communication between users (e.g., sender and recipient of a message) over a wired or wireless communications network, through use of a communication message. The messaging application may be employed by the service provider referenced in FIG. 11. For instance, the service provider can offer messaging services that provides a communication service to users via a messaging application (e.g., chat or messaging capability). The messaging application may include, for example, a text messaging application for communication between phones (e.g., conventional mobile telephones or smartphones), or a cross-platform instant messaging application for smartphones and phones that use the Internet for communication.

The messaging application may be executed on a user device 1106 (e.g., mobile device or conventional personal computer (PC)) based on instructions transmitted to and from the server(s) 1102 (which, in such an example may be called a “messaging server”). In some instances, the messaging application may include a payment service application with messaging capability that enables users of the payment service application to communicate with one another. In such instances, the payment service application may be executed on a user device 1106 based on instructions transmitted to and from the server(s) 1102 (e.g., the payment service discussed in this description or another payment service that supports payment transactions). In some examples, the messaging application may be provided by a third-party service provider associated with the server(s) 1110. In examples where the messaging application is a third-party service provider, the server(s) 1110 may be accessible via one or more APIs or other integrations.

As described above, the service provider can facilitate peer-to-peer transactions, which can enable users 1114 to transfer fiat currency, non-fiat currency, cryptocurrency, securities, or other assets, or portions thereof, to other users 1114. In at least one example, individual users may be associated with accounts. Additional details associated with accounts and the transfer of assets between users 1114 are described below with reference to FIG. 12.

Furthermore, the service provider of FIG. 11 can enable users 1114 to perform banking transactions via instances of the payment service application 1118. For example, users can configure direct deposits or other deposits for adding assets to their various ledgers/balances. Further, users 1114 can configure bill pay, recurring payments, and/or the like using assets associated with their accounts. In addition to sending and/or receiving assets via peer-to-peer transactions, users 1114 buy and/or sell assets via asset networks such as cryptocurrency networks, securities networks, and/or the like.

FIG. 12 illustrates example datastore(s) 1200 that may be associated with the server(s) 1102.

In at least one example, the datastore(s) 1200 can store assets in an asset storage 1202, as well as data in account(s) 1204. In some examples, account(s) 1204 may include merchant account(s) 1206, and/or customer account(s) 1208. In at least one example, the asset storage 1202 may be used to store assets managed by the service provider of FIG. 11. In at least one example, the asset storage 1202 may be used to record whether individual of the assets are registered to users. For example, the asset storage 1202 may include an asset wallet 1210 for storing records of assets owned by the service provider of FIG. 11, such as cryptocurrency, securities, or the like, and communicating with one or more asset networks, such as cryptocurrency networks, securities networks, or the like. In some examples, the asset network may be a first-party network or a third-party network, such as a cryptocurrency exchange or the stock market. In examples where the asset network is a third-party network, the server(s) 1110 may be associated therewith. In some examples, the asset wallet 1210 can communicate with the asset network via one or more components associated with the server(s) 1102.

The asset wallet 1210 may be associated with one or more addresses and can vary addresses used to acquire assets (e.g., from the asset network(s)) so that its holdings are represented under a variety of addresses on the asset network. In examples where the service provider of FIG. 11 has its own holdings of cryptocurrency (e.g., in the asset wallet 1210), a user can acquire cryptocurrency directly from the service provider of FIG. 11. In some examples, the service provider of FIG. 11 may include logic for buying and selling cryptocurrency to maintain a desired level of cryptocurrency. In some examples, the desired level may be based on a volume of transactions over a period of time, balances of collective cryptocurrency ledgers, exchange rates, or trends in changing of exchange rates such that the cryptocurrency is trending towards gaining or losing value with respect to the fiat currency. In all of these scenarios, the buying and selling of cryptocurrency, and therefore the associated updating of the public ledger of asset network may be separate from any customer-merchant transaction or peer-to-peer transaction, and therefore not necessarily time-sensitive. This can enable batching transactions to reduce computational resources and/or costs. The service provider can provide the same or similar functionality for securities or other assets.

The asset storage 1202 may contain ledgers that store records of assignments of assets to users 1114. Specifically, the asset storage 1202 may include asset ledger 1210, fiat currency ledger 1214, and other ledger(s) 1216, which may be used to record transfers of assets between users 1114 of the service provider and/or one or more third-parties (e.g., merchant network(s), payment card network(s), ACH network(s), equities network(s), the asset network, securities networks, etc.). In doing so, the asset storage 1202 can maintain a running balance of assets managed by the service provider of FIG. 11. The ledger(s) of the asset storage 1202 can further indicate some of the running balance for each of the ledger(s) stored in the asset storage 1202 is assigned or registered to one or more account(s) 1204.

In at least one example, the asset storage 1202 may include transaction logs 1218, which may include records of past transactions involving the service provider of FIG. 11. In at least one example, transaction data, as described herein, may be stored in association with the transaction logs 1218.

In some examples, the datastore(s) 1200 can store a private blockchain 1219. A private blockchain 1219 can function to record sender addresses, recipient data, public keys, values of cryptocurrency transferred, and/or may be used to verify ownership of cryptocurrency tokens to be transferred. In some examples, the service provider of FIG. 11 can record transactions taking place within the service provider of FIG. 11 involving cryptocurrency until the number of transactions has exceeded a determined limit (e.g., number of transactions, storage space allocation, etc.). Based at least in part on determining that the limit has been reached, the service provider of FIG. 11 can publish the transactions in the private blockchain 1219 to a public blockchain (e.g., associated with the asset network), where miners can verify the transactions and record the transactions to blocks on the public blockchain. In at least one example, the service provider of FIG. 11 can participate as miner(s) at least for its transactions to be posted to the public blockchain.

In at least one example, the datastore(s) 1200 can store and/or manage accounts, such as account(s) 1204, merchant account(s) 1206, and/or customer account(s) 1208. In at least one example, the account(s) 1204 may store records of accounts associated with the users 1114. In at least one example, the account(s) 1204 may include an account 1220, which may be associated with a user (of the users 1114). Other accounts of the account(s) 1204 may be similarly structured to the account 1220, according to some examples. In other examples, other accounts may include more or less data and/or account information than that provided by the account 1220.

In at least one example, the account 1220 may include account data 1228, which may include, but is not limited to, data associated with user identifying information (e.g., name, phone number, address, etc.), user identifier(s) (e.g., alphanumeric identifiers, etc.), user preferences (e.g., learned or user-specified), purchase history data (e.g., identifying one or more items purchased (and respective item information), linked payment sources (e.g., bank account(s), stored balance(s), etc.), payment instruments used to purchase one or more items, returns associated with one or more orders, statuses of one or more orders (e.g., preparing, packaging, in transit, delivered, etc.), etc.), appointments data (e.g., previous appointments, upcoming (scheduled) appointments, timing of appointments, lengths of appointments, etc.), payroll data (e.g., employers, payroll frequency, payroll amounts, etc.), reservations data (e.g., previous reservations, upcoming (scheduled) reservations, reservation duration, interactions associated with such reservations, etc.), inventory data, user service data, loyalty data (e.g., loyalty account numbers, rewards redeemed, rewards available, etc.), risk indicator(s) (e.g., level(s) of risk), etc.

In at least one example, the account data 1228 may include account activity 1230 and user wallet key(s) 1232. The account activity 1230 may include a transaction log for recording transactions associated with the account 1220. In some examples, the user wallet key(s) 1232 may include a public-private key-pair and a respective address associated with the asset network or other asset networks. In some examples, the user wallet key(s) 1232 may include one or more key pairs, which may be unique to the asset network or other asset networks.

In addition to the account data 1228, the account 1220 may include ledger(s) for account(s) managed by the service provider of FIG. 11, for the user. For example, the account 1220 may include an assets ledger 1234, a currency ledger 1236, and/or one or more other ledgers 1238. The ledger(s) can indicate that a corresponding user utilizes the service provider of FIG. 11 to manage corresponding accounts (e.g., a cryptocurrency account, a securities account, a fiat currency account, etc.). It should be noted that in some examples, the ledger(s) may be logical ledger(s) and the data may be represented in a single database. In some examples, individual of the ledger(s), or portions thereof, may be maintained by the service provider of FIG. 11.

In some examples, the assets ledger 1234 can store a balance for each of one or more cryptocurrencies (e.g., Bitcoin, Ethereum, Litecoin, etc.) registered to the account 1220. In at least one example, the assets ledger 1234 can further record transactions of cryptocurrency assets associated with the account 1220. For example, the account 1220 can receive cryptocurrency from the asset network using the user wallet key(s) 1232. In some examples, the user wallet key(s) 1232 may be generated for the user upon request. User wallet key(s) 1232 may be requested by the user in order to send, exchange, or otherwise control the balance of cryptocurrency held by the service provider of FIG. 11 (e.g., in the asset wallet 1210) and registered to the user. In some examples, the user wallet key(s) 1232 may not be generated until an account requests such. This on-the-fly wallet key generation provides enhanced security features for users, reducing the number of access points to an account's balance and, therefore, limiting exposure to external threats.

Each account ledger can reflect a positive balance when funds are added to the corresponding account. An account may be funded by transferring currency in the form associated with the account from an external account (e.g., transferring a value of cryptocurrency to the service provider of FIG. 11 and the value is credited as a balance in assets ledger 1234), by purchasing currency in the form associated with the account using currency in a different form (e.g., buying a value of cryptocurrency from the service provider of FIG. 11 using a value of fiat currency reflected in currency ledger 1236, and crediting the value of cryptocurrency in assets ledger 1234), or by conducting a transaction with another user (customer or merchant) of the service provider of FIG. 11.

The account receives incoming currency (which may be in the form associated with the account or a different form, in which the incoming currency may be converted to the form associated with the account). In some examples, the account data 1228 may include preferences for maintaining balances of individual of the ledgers. For example, the service provider of FIG. 11 can automatically debit the currency ledger 1236 to increase the assets ledger 1234, or another account associated with the user whenever the cryptocurrency balance (e.g., of the assets ledger 1234) falls below a stated level (e.g., a threshold). Conversely, in some examples, the service provider of FIG. 11 can automatically credit the currency ledger 1236 to decrease the assets ledger 1234 whenever cryptocurrency balance rises above a stated level (e.g., a threshold). In some examples, automatic transactions may be further defined by an exchange rate between the cryptocurrency and the fiat currency such that transactions to buy or sell cryptocurrency can occur when exchange rates are favorable.

With specific reference to funding a cryptocurrency account, a user may have a balance of cryptocurrency stored in another cryptocurrency wallet. In some examples, the other cryptocurrency wallet may be associated with a third-party unrelated to the service provider of FIG. 11 (i.e., an external account). In at least one example, the user can transfer all or a portion of a balance of the cryptocurrency stored in the third-party cryptocurrency wallet to the service provider of FIG. 11. Such a transaction can request the user to transfer an amount of the cryptocurrency in a message signed by user's private key to an address provided by the service provider of FIG. 11. In at least one example, the transaction may be sent to miners to bundle the transaction into a block of transactions and to verify the authenticity of the transactions in the block. Once a miner has verified the block, the block is written to a public, distributed blockchain where the service provider of FIG. 11 can then verify that the transaction has been confirmed and can credit the user's assets ledger 1234 with the transferred amount. When an account is funded by transferring cryptocurrency from a third-party cryptocurrency wallet, an update may be made to the public blockchain. Importantly, this update of the public blockchain need not take place at a time critical moment, such as when a transaction is being processed by a merchant in store or online.

In some examples, a user can purchase cryptocurrency to fund their cryptocurrency account. In some examples, the user can purchase cryptocurrency through services offered by the service provider of FIG. 11. As described above, in some examples, the service provider of FIG. 11 can acquire cryptocurrency from a third-party source. In such examples, the asset wallet 1210 may be associated with different addresses and can vary addresses used to acquire cryptocurrency so that its holdings are represented under a variety of addresses on a blockchain. When the service provider of FIG. 11 has their own holdings of cryptocurrency, users can acquire cryptocurrency directly from the service provider of FIG. 11.

In some examples, the service provider of FIG. 11 may include logic for buying and selling cryptocurrency in order to maintain a desired level of cryptocurrency. The desired level may be based on a volume of transactions over a period, balances of collective user profiles cryptocurrency ledgers, exchange rates, or trends in changing of exchange rates such that the cryptocurrency is trending towards gaining or losing value with respect to the fiat currency. In all of these examples, the buying and selling of cryptocurrency, and therefore the associated updating of the public ledger may be separate from any customer-merchant transaction, and therefore not necessarily time-sensitive.

In examples where the service provider of FIG. 11 has its own cryptocurrency assets, cryptocurrency transferred in a transaction (e.g., data with address provided for receipt of transaction and a balance of cryptocurrency transferred in the transaction) may be stored in the asset wallet 1210. In at least one example, the service provider of FIG. 11 can credit the assets ledger 1234 of the user. Additionally, while the service provider of FIG. 11 recognizes that the user retains the value of the transferred cryptocurrency through crediting the assets ledger 1234, any person that inspects the blockchain will see the cryptocurrency as having been transferred to the service provider of FIG. 11. In some examples, the asset wallet 1210 may be associated with many different addresses. In such examples, any person that inspects the blockchain may not easily associate all cryptocurrency stored in asset wallet 1210 as belonging to the same entity. It is this presence of a private ledger that is used for real-time transactions and maintained by the service provider of FIG. 11, combined with updates to the public ledger at other times, that allows for extremely fast transactions using cryptocurrency to be achieved. In some examples, the “private ledger” can refer to the asset ledger 1210, which in some examples, can utilize the private blockchain 1219, as described herein. The “public ledger” can correspond to a public blockchain associated with the asset network.

In at least one example, a user's assets ledger 1234, currency ledger 1236, or the like may be credited when conducting a transaction with another user (customer or merchant) wherein the user receives incoming currency. In some examples, a user can receive cryptocurrency in the form of payment for a transaction with another user. In at least one example, such cryptocurrency may be used to fund the assets ledger 1234. In some examples, a user can receive fiat currency or another currency in the form of payment for a transaction with another user. In at least one example, at least a portion of such funds may be converted into cryptocurrency by the service provider of FIG. 11 and used to fund the assets ledger 1234 of the user.

As addressed above, in some examples, users can also have other accounts maintained by the service provider of FIG. 11. For example, a user can also have an account in U.S. dollars, which may be tracked, for example, via the currency ledger 1236. Such an account may be funded by transferring money from a bank account at a third-party bank to an account maintained by the service provider of FIG. 11 as is conventionally known. In some examples, a user can receive fiat currency in the form of payment for a transaction with another user. In such examples, at least a portion of such funds may be used to fund the currency ledger 1236.

In some examples, a user can have one or more internal payment cards registered with the service provider of FIG. 11. Internal payment cards may be linked to one or more of the accounts associated with the account 1220. In some examples, options with respect to internal payment cards may be adjusted and managed using an application (e.g., the payment service application 1118).

In at least one example, as described above, each ledger can correspond to an account of the user that is managed by the service provider of FIG. 11. In at least one example, individual of the accounts may be associated with a wallet or a stored balance for use in payment transactions, peer-to-peer transactions, payroll payments, etc.

In at least one example, the account 1220 may be associated with an asset wallet 1240. The asset wallet 1240 of the user may be associated with account information that may be stored in the account data 1228 and, in some examples, may be associated with the user wallet key(s) 1232. In at least one example, the asset wallet 1240 can store data indicating an address provided for receipt of a cryptocurrency transaction. In at least one example, the balance of the asset wallet 1240 may be based at least in part on a balance of the assets ledger 1234. In at least one example, funds availed via the asset wallet 1240 may be stored in the asset wallet 1240 or the asset wallet 1210. Funds availed via the asset wallet 1210 may be tracked via the assets ledger 1234. The asset wallet 1240, however, may be associated with additional cryptocurrency funds.

In at least one example, when the service provider of FIG. 11 includes a private blockchain 1219 for recording and validating cryptocurrency transactions, the asset wallet 1240 may be used instead of, or in addition to, the assets ledger 1234. For example, at least one example, a merchant can provide the address of the asset wallet 1240 for receiving payments. In an example where a customer is paying in cryptocurrency and the customer has their own cryptocurrency wallet account associated with the service provider of FIG. 11, the customer can send a message signed by its private key including its wallet address (i.e., of the customer) and identifying the cryptocurrency and value to be transferred to the merchant's asset wallet 1240.

The service provider of FIG. 11 can complete the transaction by reducing the cryptocurrency balance in the customer's cryptocurrency wallet and increasing the cryptocurrency balance in the merchant's asset wallet 1240. In addition to recording the transaction in the respective cryptocurrency wallets, the transaction may be recorded in the private blockchain 1219 and the transaction may be confirmed. A user can perform a similar transaction with cryptocurrency in a peer-to-peer transaction as described above. In at least one example, the cryptocurrency wallet account 1230 may be funded by a balance transfer from a third-party cryptocurrency wallet, as described above. Such a transaction can require a user to transfer an amount of cryptocurrency in a message signed by the user's private key to an address of the cryptocurrency wallet account 1230. The transferred amount of cryptocurrency can then be within the cryptocurrency wallet account 1230 for use in later transactions.

While the assets ledger 1234 and/or asset wallet 1240 are each described above with reference to cryptocurrency, the assets ledger 1234 and/or asset wallet 1240 can alternatively be used in association with securities. In some examples, different ledgers and/or wallets may be used for different types of assets. That is, in some examples, a user can have multiple asset ledgers and/or asset wallets for tracking cryptocurrency, securities, or the like.

It should be noted that user(s) having accounts managed by the service provider of FIG. 11 is an aspect of the technology disclosed that enables technical advantages of increased processing speed and improved security.

In some examples, the datastore(s) 1200 may also include any number of ledgers 1234, 1236, and 1238 that may be iteratively updated in real-time or near real-time in accordance with various user or payment service transactions. For example, a user profile may also include a ledger for any accounts managed by the datastore(s) 1200 on behalf of the user. It will be appreciated that users having accounts managed by the datastore(s) 1200 is an aspect of the technology that enables technical advantages of increased processing speed and improved security. For example, the user profile may include a currency ledger 1236. The currency ledger 1236 may store a balance (e.g., unrestricted balance 134) for each of one or more currencies (e.g., US dollar, Euro, bitcoin) that the user owns. The user profile may also include an assets ledger 1234. The assets ledger 1234 may store a balance for each of one or more security assets (e.g., stocks, bonds, futures) that the customer owns. The user profile may also include a cryptocurrency ledger. The cryptocurrency ledger may store a balance for each of one or more cryptocurrencies that the customer owns. The user profile may also include a loan ledger, the loan ledger may store a balance that the user owes or is owed, and the corresponding terms, for each of one or more loans taken by the user or offered by the user to other users. The ledgers may utilize any suitable data structure.

In some examples, a separate ledger may be used to record information about each individual asset owned by the user. Various ledgers associated with a particular user may be stored all together, in groups, or separately. As another example and not by way of limitation, the currency ledger 1236, assets ledger 1234, cryptocurrency ledger, and loan ledger, may be logical ledgers. The balances associated with the ledgers may all be saved in a single file, data set, or data store. In other words, a user's ownership interest in multiple types of assets may all be recorded in a composite ledger or be separated recorded in multiple ledgers.

Each user account ledger may reflect a positive balance when a user funds the accounts. An account may be funded by transferring currency in the form associated with the account from an external account (e.g., transferring a quantity of cash to the payment service and the value is credited as a balance in currency ledger 1236), or by purchasing currency in the form associated with the account from the datastore(s) 1200 using currency in a different form (e.g., buying a value of cryptocurrency from datastore(s) 1200 using a value of fiat currency, and crediting the value of cryptocurrency in a currency ledger 1236), or by conducting a transaction with another user of the datastore(s) 1200 wherein the account receives incoming currency. An account may be funded by purchasing security assets via the datastore(s) 1200. When a user requests to purchase security assets from the payment service, the payment service may debit a balance stored in the currency ledger 1236 and credit a balance stored in the assets ledger 1234. In some examples, a user profile may include preference settings as to a quantity of security assets to keep.

As an example, and not by way of limitation, the datastore(s) 1200 may automatically cause a sale of security assets (or other assets) for the user, thus debiting the assets ledger 1234 (or other corresponding ledger) and crediting the currency ledger 1236. As an example, the transactions component 123 may cause these operations upon receiving instructions from the user or acting on prior authorization of the user. As another example, the transactions component 123 may cause automatic sales of assets when the datastore(s) 1200 determines a risk index associated with the security assets owned by the user exceeds a threshold value. As another example and not by way of limitation, the transactions component 123 may automatically cause a purchase of security assets by the user when a balance associated with the assets ledger 1234 drops below a stated level. The user profile may also comprise preference settings as to a preferred asset for payments (e.g., a preference to use a particular security asset to pay for day-to-day transactions).

The datastore(s) 1200 may also enter into contractual relationships with one or more sources such that the sources provide liquidity of security assets to the payment service. The datastore(s) 1200 may maintain a currency ledger 1236 recording a quantity of cash or other currencies held by the datastore(s) 1200, an assets ledger 1234 recording a quantity of security assets held by the datastore(s) 1200, and other appropriate ledgers recording a quantity of other assets or obligations (e.g., loans payable) held by the datastore(s) 1200. The currency ledger 1236 and the assets ledger 1234 may also specify the portion of the assets held by the datastore(s) 1200 that is owned by one or more users of the datastore(s) 1200 and the portion of the assets that is owned by the datastore(s) 1200. When the datastore(s) 1200 has its own holdings of security assets, user may acquire security assets directly from the datastore(s) 1200. In some examples, the datastore(s) 1200 may use artificial intelligence, including computational models or algorithms, to dynamically and intelligently control buying and selling activities with respect to security assets and other assets. The algorithms may be designed for maintaining the assets owned by the datastore(s) 1200 at a desired level. The desired level may be based on a volume of transactions over a period, balances of collective ledgers in user profiles, exchange rates, or trends in prices of security assets and other assets.

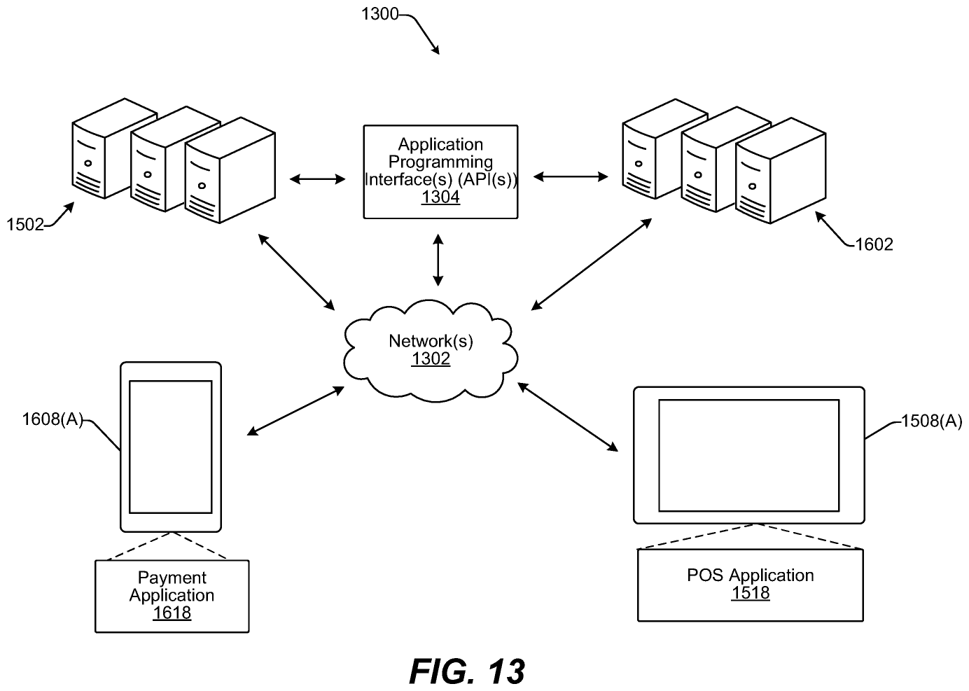

FIG. 13 illustrates an example environment 1300 wherein the environment 1000 and the environment 1100 may be integrated to enable payments at the point-of-sale using assets associated with accounts in the peer-to-peer environment of FIG. 11. As illustrated, each of the components can communicate with one another via one or more networks 1302. In some examples, one or more APIs 1304 or other functional components may be used to facilitate such communication.

In at least one example, the example environment 1300 can enable contactless payments, via integration of peer-to-peer payment, or other payment making, platform(s) and payment processing platform(s), are described herein. For the purpose of FIG. 13, the environment 1300 can refer to a payment processing platform and the environment 1100 can refer to a peer-to-peer payment, or payment making, platform. In an example, such an integration can enable a customer to participate in a transaction via their own computing device instead of interacting with a merchant device of a merchant, such as the merchant device 1308(A). In such an example, the POS application 1318, associated with a payment processing platform and executable by the merchant device 1308(A) of the merchant, can present a Quick Response (QR) code, or other code that may be used to identify a transaction (e.g., a transaction code), in association with a transaction between the customer and the merchant. The QR code, or other transaction code, may be provided to the POS application 1318 via an API associated with the peer-to-peer payment platform. In an example, the customer can utilize their own computing device, such as the user device 1108(A), to capture the QR code, or the other transaction code, and to provide an indication of the captured QR code, or other transaction code, to server(s) 1302 and/or server(s) 1102.

Based at least in part on the integration of the peer-to-peer payment platform and the payment processing platform (e.g., via the API), the server(s) 1302 and/or 1102 associated with each can exchange communications with each other—and with a payment service application 1118 associated with the peer-to-peer payment platform and/or the POS application 1318—to process payment for the transaction using a peer-to-peer payment where the customer is a first “peer” and the merchant is a second “peer.” In at least one example, the peer-to-peer payment platform can transfer funds from an account of the customer, maintained by the peer-to-peer payment platform, to an account of the merchant, maintained by the payment processing platform, thereby facilitating a contactless (peer-to-peer) payment for the transaction. That is, based at least in part on receiving an indication of which payment method a user (e.g., customer or merchant) intends to use for a transaction, techniques described herein utilize an integration between a peer-to-peer payment platform and payment processing platform (which may be a first- or third-party integration) such that a QR code, or other transaction code, specific to the transaction may be used for providing transaction details, location details, customer details, or the like to a computing device of the customer, such as the user device 1108(A), to enable a contactless (peer-to-peer) payment for the transaction.

In at least one example, techniques described herein can offer improvements to conventional payment technologies at both brick-and-mortar points of sale and online points of sale. For example, at brick-and-mortar points of sale, techniques described herein can enable customers to “scan to pay,” by using their computing devices to scan QR codes, or other transaction codes, encoded with data as described herein, to remit payments for transactions. In such a “scan to pay” example, a customer computing device, such as the user device 1108(A), may be specially configured as a buyer-facing device that can enable the customer to view cart building in near real-time, interact with a transaction during cart building using the customer computing device, authorize payment via the customer computing device, apply coupons or other incentives via the customer computing device, add gratuity, loyalty information, feedback, or the like via the customer computing device, etc. In another example, merchants can “scan for payment” such that a customer can present a QR code, or other transaction code, that may be linked to a payment instrument or stored balance. Funds associated with the payment instrument or stored balance may be used for payment of a transaction.

As described above, techniques described herein can offer improvements to conventional payment technologies at online points of sale, as well as brick-and-mortar points of sale. For example, multiple applications may be used in combination during checkout. That is, the POS application 1318 and the payment service application 1118, as described herein, can process a payment transaction by routing information input via the merchant application to the payment service application for completing a “frictionless” payment. This may be referred to as “in-application payment.” In another example of “in-application payment,” the payment service application described herein may be created or modified via a software developer kit (SDK) to enable in-application payment.

Returning to the “scan to pay” examples described herein, QR codes, or other transaction codes, may be presented in association with a merchant web page or ecommerce web page. In at least one example, techniques described herein can enable customers to “scan to pay,” by using their computing devices to scan or otherwise capture QR codes, or other transaction codes, encoded with data, as described herein, to remit payments for online/ecommerce transactions. In such a “scan to pay” example, a customer computing device, such as the user device 1108(A), may be specially configured as a buyer-facing device that can enable the customer to view cart building in near real-time, interact with a transaction during cart building using the customer computing device, authorize payment via the customer computing device, apply coupons or other incentives via the customer computing device, add gratuity, loyalty information, feedback, or the like via the customer computing device, etc.

In an example, a customer can desire to purchase items from a merchant. When the customer approaches the merchant to check out, the merchant (e.g., a worker associated therewith) can add indications of the items to a virtual cart via the POS application 1318, associated with a payment processing platform, on the merchant device 1308(A). In an example, the merchant can use the payment processing platform to process payments, and the payment processing platform can process payments for the merchant, as well as other merchants. That is, the payment processing platform may be an aggregator. After adding the first item, or otherwise providing an indication to start a transaction, a display of the merchant device 1308(A) can present a QR code, or other transaction code, that may be associated with a peer-to-peer payment platform. The customer can use a camera associated with the user device 1108(A) to scan, or otherwise capture, the QR code.

If the customer is already associated with the peer-to-peer payment platform (e.g., has an existing account, previously onboarded, etc.), the peer-to-peer platform can provide an indication of the scanned QR code to the payment processing platform. This interaction-between the customer computing device and the QR code—can trigger communications between the peer-to-peer payment platform and the payment processing platform (e.g., via an API) to facilitate a transfer of funds from a stored balance of the customer, that is managed and/or maintained by the peer-to-peer payment platform, to a stored balance of the merchant, that is managed and/or maintained by the payment processing platform. As such, the customer can use such funds for contactless payment of the transaction. Such a payment may be structured as a peer-to-peer payment wherein the customer is the first “peer” and the payment processing platform is the second “peer.” The payment processing platform can deposit funds received from the peer-to-peer payment platform in an account of the merchant to settle the transaction on behalf of the merchant. In some examples, the payment processing platform can deposit funds into an account of the merchant to settle the transaction prior to receiving funds from the peer-to-peer payment platform.

As an additional or alternative example, a customer can desire to purchase items from a merchant. When the customer approaches the merchant to check out, the merchant (e.g., a worker associated therewith) can add indications of the items to a virtual cart via the POS application 1318, associated with a payment processing platform, on the merchant device 1308(A). In an example, the merchant can use the payment processing platform to process payments, and the payment processing platform can process payments for the merchant, as well as other merchants. That is, the payment processing platform may be an aggregator. After adding the first item, or otherwise providing an indication to start a transaction, the POS application 1318 can cause a text message with a resource locator (e.g., uniform resource locator (URL)) that may be associated with a peer-to-peer payment platform to be sent to the user device 1108(A). The customer can interact with the resource locator and, if the customer is already associated with the peer-to-peer payment platform (e.g., has an existing account, previously onboarded, etc.), the peer-to-peer payment platform can provide an indication of the interaction with the resource locator to the payment processing platform.

This interaction-between the customer and the resource locator presented via the customer computing device—can trigger communications between the peer-to-peer payment platform and the payment processing platform (e.g., via an API) to facilitate a transfer of funds from a stored balance of the customer, that is managed and/or maintained by the peer-to-peer payment platform, to a stored balance of the merchant, that is managed and/or maintained by the payment processing platform. As such, the customer can use such funds for contactless payment of the transaction. As described above, such a payment may be structured as a peer-to-peer payment wherein the customer is the first “peer” and the payment processing platform is the second “peer.” The payment processing platform can deposit funds received from the peer-to-peer payment platform in an account of the merchant to settle the transaction on behalf of the merchant. In some examples, the payment processing platform can deposit funds into an account of the merchant to settle the transaction prior to receiving funds from the peer-to-peer payment platform.

The same or similar techniques may be applicable in online and/or ecommerce selling channels as well. In such an example, a QR code, or other transaction code, may be presented via an online store/ecommerce web page of a merchant. The customer can use a camera associated with a customer computing device, such as the user device 1108(A), to scan, or otherwise capture, the QR code. If the customer is already associated with the peer-to-peer payment platform (e.g., has an existing account, previously onboarded, etc.), the peer-to-peer platform can provide an indication of the scanned QR code to the payment processing platform. This interaction-between the customer computing device and the QR code—can trigger communications between the peer-to-peer payment platform and the payment processing platform (e.g., via an API) to facilitate a transfer of funds from a stored balance of the customer, that is managed and/or maintained by the peer-to-peer payment platform, to a stored balance of the merchant, that is managed and/or maintained by the payment processing platform.

As such, the customer can use such funds for contactless payment of the transaction. Such a payment may be structured as a peer-to-peer payment wherein the customer is the first “peer” and the payment processing platform is the second “peer.” The payment processing platform can deposit funds received from the peer-to-peer payment platform in an account of the merchant to settle the transaction on behalf of the merchant. In some examples, the payment processing platform can deposit funds into an account of the merchant to settle the transaction prior to receiving funds from the peer-to-peer payment platform.

As described above, techniques described herein offer improvements to conventional payment technologies. In an example, techniques described herein can enable transaction data to be sent from a POS application 1318 of a merchant device 1008(A) at a brick-and-mortar store of a merchant to a payment service application 1118 of a user device 1108(A) of a customer to enable the customer to participate in a transaction via their own computing device. For instance, in a “scan to pay” example as described above, based at least in part on capturing the QR code, or other transaction code, via the user device 1108(A), the payment processing platform can provide transaction data to the peer-to-peer payment platform for presentation via the payment service application 1118 on the user device 1108(A). In some examples, the customer can watch items being added to their cart (e.g., via a user interface presented via the payment service application).

As an item is added to a virtual cart by the merchant-via the POS application 1318 on the merchant device 1008(A) of the merchant—the customer can see the item in their virtual cart on their own computing device in near-real time. In another example, the peer-to-peer payment platform can analyze transaction data as it is received to determine whether an incentive (e.g., a discount, a loyalty reward, prioritized access or booking, etc.) is applicable to the transaction and can automatically apply the incentive or send a recommendation to the payment service application 1118 for presentation via a user interface associated therewith. In addition to enabling a customer to participate in a transaction during cart building, techniques described herein can enable a customer to complete a transaction, and in some examples, provide gratuity (i.e., a tip), feedback, loyalty information, or the like, via the user device 1108(A) during or after payment of the transaction.

In some examples, based at least in part on capturing the QR code, or other transaction code, the payment processing platform can provide transaction data to the peer-to-peer payment platform for presentation via the payment service application 1118 on the computing device of the customer, such as the user device 1108(A), to enable the customer to complete the transaction via their own computing device. In some examples, in response to receiving an indication that the QR code, or other transaction code, has been captured or otherwise interacted with via the customer computing device, the peer-to-peer payment platform can determine that the customer authorizes payment of the transaction using funds associated with a stored balance of the customer that is managed and/or maintained by the peer-to-peer payment platform. Such authorization may be implicit such that the interaction with the transaction code can imply authorization of the customer.

In some examples, in response to receiving an indication that the QR code, or other transaction code, has been captured or otherwise interacted with via the customer computing device, the peer-to-peer payment platform can request authorization to process payment for the transaction using the funds associated with the stored balance and the customer can interact with the payment service application to authorize the settlement of the transaction. A response to such a request can provide an express authorization of the customer. In some examples, such an authorization (implicit or express) may be provided prior to a transaction being complete and/or initialization of a conventional payment flow. That is, in some examples, such an authorization may be provided during cart building (e.g., adding item(s) to a virtual cart) and/or prior to payment selection.

In some examples, such an authorization may be provided after payment is complete (e.g., via another payment instrument). Based at least in part on receiving an authorization to use funds associated with the stored balance (e.g., implicitly or explicitly) of the customer, the peer-to-peer payment platform can transfer funds from the stored balance of the customer to the payment processing platform. In at least one example, the payment processing platform can deposit the funds, or a portion thereof, into a stored balance of the merchant that is managed and/or maintained by the payment processing platform. That is, techniques described herein enable the peer-to-peer payment platform to transfer funds to the payment processing platform to settle payment of the transaction. In such an example, the payment processing platform may be a “peer” to the customer in a peer-to-peer transaction.

In some examples, techniques described herein can enable the customer to interact with the transaction after payment for the transaction has been settled. For example, in at least one example, the payment processing platform can cause a total amount of a transaction to be presented via a user interface associated with the payment service application 1118 such that the customer can provide gratuity, feedback, loyalty information, or the like, via an interaction with the user interface. In some examples, because the customer has already authorized payment via the peer-to-peer payment platform, if the customer inputs a tip, the peer-to-peer payment platform can transfer additional funds, associated with the tip, to the payment processing platform. This pre-authorization (or maintained authorization) of sorts can enable faster, more efficient payment processing when the tip is received. Further, the customer can provide feedback and/or loyalty information via the user interface presented by the payment service application, which may be associated with the transaction.

As described above—and also below-techniques described herein enable contactless payments. That is, by integrating the payment processing platform with the peer-to-peer payment platform, merchants and customers can participate in transactions via their own computing devices without needing to touch, or otherwise be in contact, with one another. By moving aspects of a transaction that are traditionally performed on a computing device of a merchant to a computing device of a customer, customers can have more control over the transaction and can have more privacy. That is, customers can monitor items that are added to their cart to ensure accuracy. Further, customers can authorize payments, use rewards, claim incentives, add gratuity, or the like without being watched by the merchant or other customers.

In some examples, such as when the QR code, or other transaction code, is captured by the computing device of the customer prior to a payment selection user interface being presented via the POS application 1318, payment for the transaction may be pre-authorized such that when the time comes to complete the transaction, neither the payment processing platform nor the peer-to-peer payment platform need to re-authorize payment at that time. That is, techniques described herein can enable faster, more efficient transactions. Further, in some examples, when a customer adds a tip after payment for a transaction has been settled, in some examples, because the peer-to-peer payment platform has already been authorized, the peer-to-peer payment platform and the payment processing platform may not need to obtain another authorization to settle funds associated with the tip. That is, in such examples, fewer data transmissions are required and thus, techniques described herein can conserve bandwidth and reduce network congestion. Moreover, as described above, funds associated with tips may be received faster and more efficiently than with conventional payment technologies.

In addition to the improvements described above, techniques described herein can provide enhanced security in payment processing. In some examples, if a camera, or other sensor, used to capture a QR code, or other transaction code, is integrated into a payment service application 1118 (e.g., instead of a native camera, or other sensor), techniques described herein can utilize an indication of the QR code, or other transaction code, received from the payment service application for two-factor authentication to enable more secure payments.

It should be noted that, while techniques described herein are directed to contactless payments using QR codes or other transaction codes, in additional or alternative examples, techniques described herein may be applicable for contact payments. That is, in some examples, instead of scanning, capturing, or otherwise interacting with a QR code or transaction code, a customer can swipe a payment instrument (e.g., a credit card, a debit card, or the like) via a reader device associated with a merchant device, dip a payment instrument into a reader device associated with a merchant computing device, tap a payment instrument with a reader device associated with a merchant computing device, or the like, to initiate the provisioning of transaction data to the customer computing device.

For example, based at least in part on detecting a dip, tap, swipe, or the like, the payment processing platform can associate a customer with a transaction and provide at least a portion of transaction data associated with the transaction to a customer computing device associated therewith. In some examples, the payment instrument may be associated with the peer-to-peer payment platform as described herein (e.g., a debit card linked to a stored balance of a customer) such that when the payment instrument is caused to interact with a payment reader, the payment processing platform can exchange communications with the peer-to-peer payment platform to authorize payment for a transaction and/or provision associated transaction data to a computing device of the customer associated with the transaction.

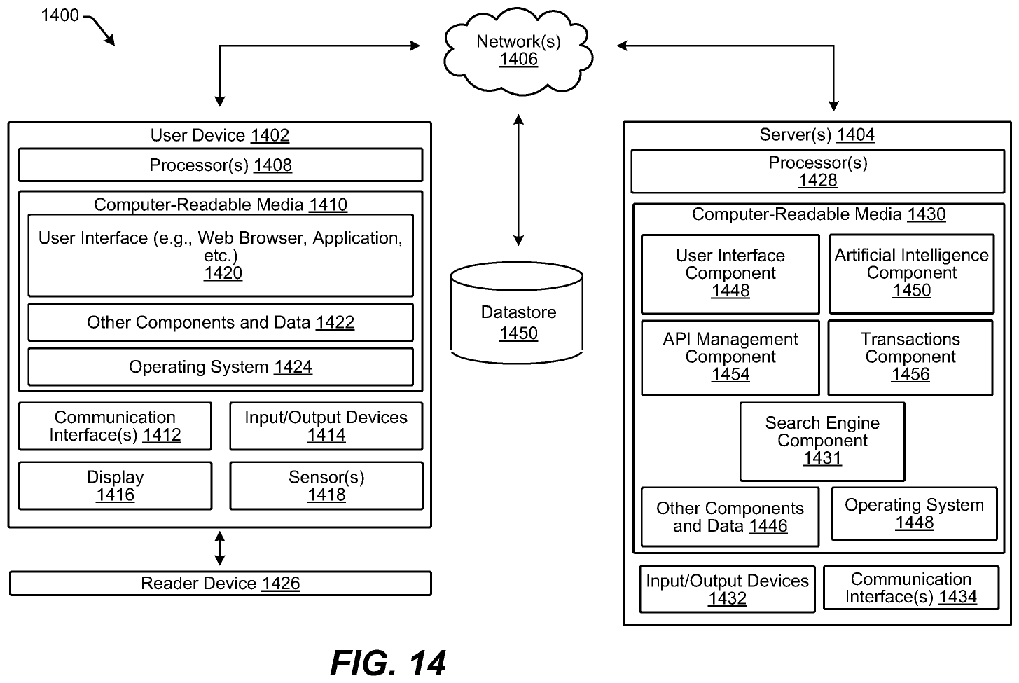

FIG. 14 depicts an illustrative block diagram illustrating a system 1400 for performing techniques described herein. The system 1400 includes a user device 1402, that communicates with server computing device(s) (e.g., server(s) 1404) via network(s) 1406 (e.g., the Internet, cable network(s), cellular network(s), cloud network(s), wireless network(s) (e.g., Wi-Fi) and wired network(s), as well as close-range communications such as Bluetooth®, Bluetooth® low energy (BLE), and the like). While a single user device 1402 is illustrated, in additional or alternate examples, the system 1400 can have multiple user devices, as described above with reference to FIG. 10.

Certain elements of environment 100 described with respect to FIG. 1 correspond to similar elements described herein with respect to FIG. 14. For example, the server(s) 1404 can correspond to server(s) 104, the network(s) 1406 can correspond to the network(s) 101, the user device(s) 1102 can correspond to any of the user device(s) 112, the datastore 1450 can correspond to datastore 118, etc.

Similar to server(s) 104, server(s) 1406 can store one or more functional components that enable the payment service to perform operations as described herein. For example, the server(s) 1404 can store user interface component 1448 (which may function similarly to user interface component 117), an artificial intelligence component 1450 (which may function similarly to artificial intelligence component 118), API management component 1452 (which may function similarly to API management component 119), a search engine component 1431 (which may function similarly to search engine component 131), and a transactions component 1458 (which may function similarly to transaction component 120). Each component can function similarly to the respective components described in FIG. 1.

In at least one example, the user device 1402 may be any suitable type of computing device, e.g., portable, semi-portable, semi-stationary, or stationary. Some examples of the user device 1402 may include, but are not limited to, a tablet computing device, a smart phone or mobile communication device, a laptop, a netbook or other portable computer or semi-portable computer, a desktop computing device, a terminal computing device or other semi-stationary or stationary computing device, a dedicated device, a wearable computing device or other body-mounted computing device, an augmented reality device, a virtual reality device, an Internet of Things (IoT) device, etc. That is, the user device 1402 may be any computing device capable of sending communications and performing the functions according to the techniques described herein. The user device 1402 may include devices, e.g., payment card readers, or components capable of accepting payments, as described below.

In the illustrated example, the user device 1402 includes one or more processors 1408, one or more computer-readable media 1410, one or more communication interface(s) 1412, one or more input/output (I/O) devices 1414, a display 1416, and sensor(s) 1418.

In at least one example, each processor 1408 can itself comprise one or more processors or processing cores. For example, the processor(s) 1408 may be implemented as one or more microprocessors, microcomputers, microcontrollers, digital signal processors, central processing units, state machines, logic circuitries, and/or any devices that manipulate signals based on operational instructions. In some examples, the processor(s) 1408 may be one or more hardware processors and/or logic circuits of any suitable type specifically programmed or configured to execute the algorithms and processes described herein. The processor(s) 1408 may be configured to fetch and execute computer-readable processor-executable instructions stored in the computer-readable media 1410.

Depending on the configuration of the user device 1402, the computer-readable media 1410 may be an example of tangible non-transitory computer storage media and may include volatile and nonvolatile memory and/or removable and non-removable media implemented in any type of technology for storage of information such as computer-readable processor-executable instructions, data structures, program components or other data. The computer-readable media 1410 may include, but is not limited to, RAM, ROM, EEPROM, flash memory, solid-state storage, magnetic disk storage, optical storage, and/or other computer-readable media technology. Further, in some examples, the user device 1402 can access external storage, such as RAID storage systems, storage arrays, network attached storage, storage area networks, cloud storage, or any other medium that may be used to store information and that may be accessed by the processor(s) 1408 directly or through another computing device or network. Accordingly, the computer-readable media 1410 may be computer storage media able to store instructions, components or components that may be executed by the processor(s) 1408. Further, when mentioned, non-transitory computer-readable media exclude media such as energy, carrier signals, electromagnetic waves, and signals per se.

The computer-readable media 1410 may be used to store and maintain any number of functional components that are executable by the processor(s) 1408. In some implementations, these functional components comprise instructions or programs that are executable by the processor(s) 1408 and that, when executed, implement operational logic for performing the actions and services attributed above to the user device 1402. Functional components stored in the computer-readable media 1410 may include a user interface 1420 to enable users to interact with the user device 1402, and thus the server(s) 1404 and/or other networked devices. In at least one example, the user interface 1420 may be presented via a web browser, or the like.

In other examples, the user interface 1420 may be presented via an application, such as a mobile application or desktop application, which may be provided by a service provider associated with the server(s) 1404, or which may be an otherwise dedicated application. In some examples, the user interface 1420 may be FIGS. 2A-3. In at least one example, a user can interact with the user interface via touch input, spoken input, gesture, or any other type of input. The word “input” is also used to describe “contextual” input that may not be directly provided by the user via the user interface 1420. For example, user's interactions with the user interface 1420 are analyzed using, e.g., natural language processing techniques, to determine context or intent of the user, which may be treated in a manner similar to “direct” user input.

Depending on the type of the user device 1402, the computer-readable media 1410 can also optionally include other functional components and data, such as other components and data 1122, which may include programs, drivers, etc., and the data used or generated by the functional components. In addition, the computer-readable media 1410 can also store data, data structures and the like, that are used by the functional components. Further, the user device 1402 may include many other logical, programmatic and physical components, of which those described are merely examples that are related to the discussion herein.

In at least one example, the computer-readable media 1410 may include additional functional components, such as an operating system 1124 for controlling and managing various functions of the user device 1402 and for enabling basic user interactions.

The communication interface(s) 1412 may include one or more interfaces and hardware components for enabling communication with various other devices, such as over the network(s) 1406 or directly. For example, communication interface(s) 1412 can enable communication through one or more network(s) 1406, which may include, but are not limited any type of network known in the art, such as a local area network or a wide area network, such as the Internet, and may include a wireless network, such as a cellular network, a cloud network, a local wireless network, such as Wi-Fi and/or close-range wireless communications, such as Bluetooth®, BLE, NFC, RFID, a wired network, or any other such network, or any combination thereof. Accordingly, network(s) 1406 may include both wired and/or wireless communication technologies, including Bluetooth®, BLE, Wi-Fi and cellular communication technologies, as well as wired or fiber optic technologies. Components used for such communications can depend at least in part upon the type of network, the environment selected, or both. Protocols for communicating over such networks are well known and will not be discussed herein in detail.

Embodiments of the disclosure may be provided to users through a cloud computing infrastructure. Cloud computing refers to the provision of scalable computing resources as a service over a network, to enable convenient, on-demand network access to a shared pool of configurable computing resources that may be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

The user device 1402 can further include one or more input/output (I/O) devices 1414. The I/O devices 1414 may include speakers, a microphone, a camera, and various user controls (e.g., affordances, a joystick, a keyboard, a keypad, etc.), a haptic output device, and so forth. The I/O devices 1414 can also include attachments that leverage the accessories (audio-jack, USB-C, Bluetooth, etc.) to connect with the user device 1402.

In at least one example, user device 1402 may include a display 1416. Depending on the type of computing device(s) used as the user device 1402, the display 1416 can employ any suitable display technology. For example, the display 1416 may be a liquid crystal display, a plasma display, a light emitting diode display, an OLED (organic light-emitting diode) display, an electronic paper display, or any other suitable type of display able to present digital content thereon. In at least one example, the display 1416 may be an augmented reality display, a virtually reality display, or any other display able to present and/or project digital content. In some examples, the display 1416 can have a touch sensor associated with the display 1416 to provide a touchscreen display configured to receive touch inputs for enabling interaction with a graphic interface presented on the display 1416. Accordingly, implementations herein are not limited to any particular display technology. Alternatively, in some examples, the user device 1402 may not include the display 1416, and information may be presented by other means, such as aurally, haptically, etc.

In addition, the user device 1402 may include sensor(s) 1418. The sensor(s) 1418 may include a GPS device able to indicate location information. Further, the sensor(s) 1418 may include, but are not limited to, an accelerometer, gyroscope, compass, proximity sensor, camera, microphone, and/or a switch.

In some example, the GPS device may be used to identify a location of a user. In at least one example, the location of the user may be used by the service provider, described above, to provide one or more services. That is, in some examples, the service provider can implement geofencing to provide particular services to users. As an example, with a lending service, location may be used to confirm that a stated purpose of a loan corresponds to evidence of use (e.g., Is the user using the loan consistent with what he or she said he or she was going to use it for?). Furthermore, in some examples, location may be used for payroll purposes.

As an example, if a contractor completes a project, the contractor can provide a geo-tagged image (e.g., tagged based on location information availed by the GPS device). In some examples, location may be used for facilitating peer-to-peer payments between nearby users and/or for sending users notifications regarding available appointments with merchant(s) located proximate to the users. In at least one example, location may be used for taking payments from nearby customers when they leave a geofence, or location may be used to initiate an action responsive to users 614 enter a brick-and-mortar store of a merchant. Location may be used in additional or alternative ways as well.

Additionally, the user device 1402 may include various other components that are not shown, examples of which include removable storage, a power source, such as a battery and power control unit, a barcode scanner, a printer, a cash drawer, and so forth.

In addition, in some examples, the user device 1402 may include, be connectable to, or otherwise be coupled to a reader device 1426, for reading payment instruments and/or identifiers associated with payment objects. In some examples, as described above, the reader device 1426 can plug in to a port in the user device 1402, such as a microphone port, a headphone port, an audio-jack, a data port, or other suitable port. In additional or alternative examples, the reader device 1426 may be coupled to the user device 1402 via another wired or wireless connection, such as via a Bluetooth®, BLE, and so on. The reader device 1426 may include a read head for reading a magnetic strip of a payment card, and further may include encryption technology for encrypting the information read from the magnetic strip. Additionally, or alternatively, the reader device 1426 may be an EMV payment reader, which in some examples, may be embedded in the user device 1402. Moreover, numerous other types of readers may be employed with the user device 1402 herein, depending on the type and configuration of the user device 1402.

The reader device 1426 may be a portable magnetic stripe card reader, optical scanner, smartcard (card with an embedded IC chip) reader (e.g., an EMV-compliant card reader or short-range communication-enabled reader), RFID reader, or the like, configured to detect and obtain data off any payment instrument. Accordingly, the reader device 1426 may include hardware implementation, such as slots, magnetic tracks, and rails with one or more sensors or electrical contacts to facilitate detection and acceptance of a payment instrument. That is, the reader device 1426 may include hardware implementations to enable the reader device 1426 to interact with a payment instrument via a swipe (i.e., a card-present transaction where a customer slides a card having a magnetic strip through a payment reader that captures payment data contained in the magnetic strip), a dip (i.e., a card-present transaction where a customer inserts a card having an embedded microchip (i.e., chip) into a payment reader first until the payment reader prompts the customer to remove the card), or a tap (i.e., a card-present transaction where a customer may tap or hover his or her user device such as a smart phone running a payment service application over a payment reader to complete a transaction via short-range communication) to obtain payment data associated with a customer. Additionally, or optionally, the reader device 1426 may also include a biometric sensor to receive and process biometric characteristics and process them as payment instruments, given that such biometric characteristics are registered with the payment service and connected to a financial account with a bank server.

The reader device 1426 may include processing unit(s), computer-readable media, a reader chip, a transaction chip, a timer, a clock, a network interface, a power supply, and so on. The processing unit(s) of the reader device 1426 may execute one or more components and/or processes to cause the reader device 1426 to perform a variety of functions, as set forth above and explained in further detail in the following disclosure. In some examples, the processing unit(s) may include a central processing unit (CPU), a graphics processing unit (GPU), a CPU and a GPU, or processing units or components known in the art. Additionally, each of the processing unit(s) may possess its own local memory, which also may store program components, program data, and/or one or more operating systems. Depending on the exact configuration and type of the reader device 1426, the computer-readable media may include volatile memory (such as RAM), non-volatile memory (such as ROM, flash memory, miniature hard drive, memory card, or the like), or some combination thereof. In at least one example, the computer-readable media of the reader device 1426 may include at least one component for performing various functions as described herein.

The reader chip may perform functionalities to control the operations and processing of the reader device 1426. That is, the reader chip may perform functionalities to control payment interfaces (e.g., a contactless interface, a contact interface, etc.), a wireless communication interface, a wired interface, a user interface (e.g., a signal condition device (FPGA)), etc. Additionally, the reader chip may perform functionality to control the timer, which may provide a timer signal indicating an amount of time that has lapsed following a particular event (e.g., an interaction, a power-down event, etc.). Moreover, the reader chip may perform functionality to control the clock, which may provide a clock signal indicating a time. Furthermore, the reader chip may perform functionality to control the network interface, which may interface with the network(s) 1406, as described below.

Additionally, the reader chip may perform functionality to control the power supply. The power supply may include one or more power supplies such as a physical connection to AC power or a battery. Power supply may include power conversion circuitry for converting AC power and generating a plurality of DC voltages for use by components of reader device 1426. When power supply includes a battery, the battery may be charged via a physical power connection, via inductive charging, or via any other suitable method.

The transaction chip may perform functionalities relating to processing of payment transactions, interfacing with payment instruments, cryptography, and other payment-specific functionality. That is, the transaction chip may access payment data associated with a payment instrument and may provide the payment data to a POS terminal, as described above. The payment data may include, but is not limited to, a name of the customer, an address of the customer, a type (e.g., credit, debit, etc.) of a payment instrument, a number associated with the payment instrument, a verification value (e.g., PIN Verification Key Indicator (PVKI), PIN Verification Value (PVV), Card Verification Value (CVV), Card Verification Code (CVC), etc.) associated with the payment instrument, an expiration data associated with the payment instrument, a primary account number (PAN) corresponding to the customer (which may or may not match the number associated with the payment instrument), restrictions on what types of charges/debts may be made, etc. Additionally, the transaction chip may encrypt the payment data upon receiving the payment data.

It should be understood that in some examples, the reader chip may have its own processing unit(s) and computer-readable media and/or the transaction chip may have its own processing unit(s) and computer-readable media. In other examples, the functionalities of reader chip and transaction chip may be embodied in a single chip or a plurality of chips, each including any suitable combination of processing units and computer-readable media to collectively perform the functionalities of reader chip and transaction chip as described herein.

While the user device 1402, which may be a POS terminal, and the reader device 1426 are shown as separate devices, in additional or alternative examples, the user device 1402 and the reader device 1426 may be part of a single device, which may be a battery-operated device. In such an example, components of both the user device 1402 and the reader device 1426 may be associated with the single device. In some examples, the reader device 1426 can have a display integrated therewith, which may be in addition to (or as an alternative of) the display 1416 associated with the user device 1402.

The server(s) 1404 may include one or more servers or other types of computing devices that may be embodied in any number of ways. For example, in the example of a server, the components, other functional components, and data may be implemented on a single server, a cluster of servers, a server farm or data center, a cloud-hosted computing service, a cloud-hosted storage service, and so forth, although other computer architectures can additionally or alternatively be used.

Further, while the figures illustrate the components and data of the server(s) 1404 as being present in a single location, these components and data can alternatively be distributed across different computing devices and different locations in any manner. Consequently, the functions may be implemented by one or more server computing devices, with the various functionality described above distributed in various ways across the different computing devices. Multiple server(s) 1404 may be located together or separately, and organized, for example, as virtual servers, server banks and/or server farms. The described functionality may be provided by the servers of a single merchant or enterprise, or may be provided by the servers and/or services of multiple different customers or enterprises.

In the illustrated example, the server(s) 1404 may include one or more processors 1128, one or more computer-readable media 1430, one or more I/O devices 1432, and one or more communication interfaces 1134. Each processor 1128 may be a single processing unit or a number of processing units, and may include single or multiple computing units or multiple processing cores. The processor(s) 1428 may be implemented as one or more microprocessors, microcomputers, microcontrollers, digital signal processors, central processing units, state machines, logic circuitries, and/or any devices that manipulate signals based on operational instructions. For example, the processor(s) 1428 may be one or more hardware processors and/or logic circuits of any suitable type specifically programmed or configured to execute the algorithms and processes described herein. The processor(s) 1428 may be configured to fetch and execute computer-readable instructions stored in the computer-readable media 1430, which can program the processor(s) 1428 to perform the functions described herein.

The computer-readable media 1430 may include volatile and nonvolatile memory and/or removable and non-removable media implemented in any type of technology for storage of information, such as computer-readable instructions, data structures, program components, or other data. Such computer-readable media 1430 may include, but is not limited to, RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that may be used to store the desired information and that may be accessed by a computing device. Depending on the configuration of the server(s) 1404, the computer-readable media 1430 may be a type of computer-readable storage media and/or may be a tangible non-transitory media to the extent that when mentioned, non-transitory computer-readable media exclude media such as energy, carrier signals, electromagnetic waves, and signals per se.

The computer-readable media 1430 may be used to store any number of functional components that are executable by the processor(s) 1428. In many implementations, these functional components comprise instructions or programs that are executable by the processors 1128 and that, when executed, specifically configure the one or more processors 1128 to perform the actions attributed above to the service provider and/or payment processing service. Functional components stored in the computer-readable media 1430 can optionally include a merchant component 1436, a training component 1438, and one or more other components and data 1440.

The merchant component 1436 may be configured to receive transaction data from POS systems, such as the POS system 624 described above with reference to FIG. 6. The merchant component 1436 can transmit requests (e.g., authorization, capture, settlement, etc.) to payment service server computing device(s) to facilitate POS transactions between merchants and customers. The merchant component 1436 can communicate the successes or failures of the POS transactions to the POS systems.

The training component 1438 may be configured to train models using machine-learning mechanisms. For example, a machine-learning mechanism can analyze training data to train a data model that generates an output, which may be a recommendation, a score, and/or another indication. Machine-learning mechanisms may include, but are not limited to supervised learning algorithms (e.g., artificial neural networks, Bayesian statistics, support vector machines, decision trees, classifiers, k-nearest neighbor, etc.), unsupervised learning algorithms (e.g., artificial neural networks, association rule learning, hierarchical clustering, cluster analysis, etc.), semi-supervised learning algorithms, deep learning algorithms, etc.), statistical models, etc. In at least one example, machine-trained data models may be stored in a datastore associated with the user device(s) 1102 and/or the server(s) 1404 for use at a time after the data models have been trained (e.g., at runtime).

The one or more other components and data 1440 may include a user interface component 1148, a balance management component 1452, a user account selection component 1454, an advance offer generating component 1456, a transactions component 1458, a training component 1460, other components and data 1462, or the like, the functionality of which is described, at least partially, above. Further, the one or more other components and data 1440 may include programs, drivers, etc., and the data used or generated by the functional components. Further, the server(s) 1404 may include many other logical, programmatic and physical components, of which those described above are merely examples that are related to the discussion herein.

The one or more “components” referenced herein may be implemented as more components or as fewer components, and functions described for the components may be redistributed depending on the details of the implementation. The term “component,” as used herein, refers broadly to software stored on non-transitory storage medium (e.g., volatile or non-volatile memory for a computing device), hardware, or firmware (or any combination thereof) components. Modules are typically functional such that they that may generate useful data or other output using specified input(s). A component may or may not be self-contained. An application program (also called an “application”) may include one or more components, or a component may include one or more application programs that may be accessed over a network or downloaded as software onto a device (e.g., executable code causing the device to perform an action). An application program (also called an “application”) may include one or more components, or a component may include one or more application programs. In additional and/or alternative examples, the component(s) may be implemented as computer-readable instructions, various data structures, and so forth via at least one processing unit to configure the computing device(s) described herein to execute instructions and to perform operations as described herein.

In some examples, a component may include one or more application programming interfaces (APIs) to perform some or all of its functionality (e.g., operations). In at least one example, a software developer kit (SDK) may be provided by the service provider to allow third-party developers to include service provider functionality and/or avail service provider services in association with their own third-party applications. Additionally, or alternatively, in some examples, the service provider can utilize an SDK to integrate third-party service provider functionality into its applications. That is, API(s) and/or SDK(s) can enable third-party developers to customize how their respective third-party applications interact with the service provider or vice versa.

The computer-readable media 1430 can additionally include an operating system 1142 for controlling and managing various functions of the server(s) 1404.

The communication interface(s) 1434 may include one or more interfaces and hardware components for enabling communication with various other devices, such as over the network(s) 1406 or directly. For example, communication interface(s) 1434 can enable communication through one or more network(s) 1406, which may include, but are not limited any type of network known in the art, such as a local area network or a wide area network, such as the Internet, and may include a wireless network, such as a cellular network, a local wireless network, such as Wi-Fi and/or close-range wireless communications, such as Bluetooth®, BLE, NFC, RFID, a wired network, or any other such network, or any combination thereof. Accordingly, network(s) 1406 may include both wired and/or wireless communication technologies, including Bluetooth®, BLE, Wi-Fi and cellular communication technologies, as well as wired or fiber optic technologies. Components used for such communications can depend at least in part upon the type of network, the environment selected, or both. Protocols for communicating over such networks are well known and will not be discussed herein in detail.

The server(s) 1404 can further be equipped with various I/O devices 1432. Such I/O devices 1432 may include a display, various user interface controls (e.g., affordances, joystick, keyboard, mouse, touch screen, biometric or sensory input devices, etc.), audio speakers, connection ports and so forth. In at least one example, the system 1400 may include a datastore 1444 that may be configured to store data that is accessible, manageable, and updatable. In some examples, the datastore 1444 may be integrated with the user device 1402 and/or the server(s) 1404. In other examples, as shown in FIG. 11, the datastore 1444 may be located remotely from the server(s) 1404 and may be accessible to the server(s) 1404. The datastore 1444 may include multiple databases and/or servers connected locally and/or remotely via the network(s) 1406. In at least one example, the datastore 1444 can store user profiles, which may include merchant profiles, customer profiles, and so on.

Merchant profiles can store, or otherwise be associated with, data associated with merchants. For instance, a merchant profile can store, or otherwise be associated with, information about a merchant (e.g., name of the merchant, geographic location of the merchant, operating hours of the merchant, employee information, etc.), a merchant category classification (MCC), item(s) offered for sale by the merchant, hardware (e.g., device type) used by the merchant, transaction data associated with the merchant (e.g., transactions conducted by the merchant, payment data associated with the transactions, items associated with the transactions, descriptions of items associated with the transactions, itemized and/or total spends of each of the transactions, parties to the transactions, dates, times, and/or locations associated with the transactions, etc.), loan information associated with the merchant (e.g., previous loans made to the merchant, previous defaults on said loans, etc.), risk information associated with the merchant (e.g., indications of risk, instances of fraud, chargebacks, etc.), appointments information (e.g., previous appointments, upcoming (scheduled) appointments, timing of appointments, lengths of appointments, etc.), payroll information (e.g., employees, payroll frequency, payroll amounts, etc.), employee information, reservations data (e.g., previous reservations, upcoming (scheduled) reservations, interactions associated with such reservations, etc.), inventory data, customer service data, etc. The merchant profile can securely store bank account information as provided by the merchant. Further, the merchant profile can store payment information associated with a payment instrument linked to a stored balance of the merchant, such as a stored balance maintained in a ledger by the service provider.

Customer profiles can store customer data including, but not limited to, customer information (e.g., name, phone number, address, banking information, etc.), customer preferences (e.g., learned or customer-specified), purchase history data (e.g., identifying one or more items purchased (and respective item information), payment instruments used to purchase one or more items, returns associated with one or more orders, statuses of one or more orders (e.g., preparing, packaging, in transit, delivered, etc.), etc.), appointments data (e.g., previous appointments, upcoming (scheduled) appointments, timing of appointments, lengths of appointments, etc.), payroll data (e.g., employers, payroll frequency, payroll amounts, etc.), reservations data (e.g., previous reservations, upcoming (scheduled) reservations, reservation duration, interactions associated with such reservations, etc.), inventory data, customer service data, etc.

Furthermore, in at least one example, the datastore 1444 can store inventory database(s) and/or catalog database(s). As described above, an inventory can store data associated with a quantity of each item that a merchant has available to the merchant. Furthermore, a catalog can store data associated with items that a merchant has available for acquisition. The datastore 1444 can store additional or alternative types of data as described herein.

The phrases “in some examples,” “according to various examples,” “in the examples shown,” “in one example,” “in other examples,” “various examples,” “some examples,” and the like generally mean the particular feature, structure, or characteristic following the phrase is included in at least one example of the present invention, and may be included in more than one example of the present invention. In addition, such phrases do not necessarily refer to the same examples or to different examples.

If the specification states a component or feature can, may, “could,” or “might” be included or have a characteristic, that particular component or feature is not required to be included or have the characteristic.

Further, the aforementioned description is directed to devices and applications that are related to payment technology. However, it will be understood, that the technology may be extended to any device and application. Moreover, techniques described herein may be configured to operate irrespective of the kind of payment object reader, POS terminal, web applications, mobile applications, POS topologies, payment cards, computer networks, and environments.

Various figures included herein are flowcharts showing example methods involving techniques as described herein. The methods illustrated are described with reference to components described in the figures for convenience and ease of understanding. However, the methods illustrated are not limited to being performed using components described the figures and such components are not limited to performing the methods illustrated herein.

Furthermore, the methods described above are illustrated as collections of blocks in logical flow graphs, which represent sequences of operations that may be implemented in hardware, software, or a combination thereof. In the context of software, the blocks represent computer-executable instructions stored on one or more computer-readable storage media that, when executed by processor(s), perform the recited operations. Generally, computer-executable instructions include routines, programs, objects, components, data structures, and the like that perform particular functions or implement particular abstract data types. The order in which the operations are described is not intended to be construed as a limitation, and any number of the described blocks may be combined in any order and/or in parallel to implement the processes. In some embodiments, one or more blocks of the process may be omitted entirely. Moreover, the methods may be combined in whole or in part with each other or with other methods.

What is claimed is:

1. A method, comprising:
causing, by a payment application provided by a payment service, a user interface to be presented, wherein the user interface is configured to enable a payor to initiate a payment to any type of a plurality of payee types, and wherein the payor has an account with the payment service;
receiving, via the user interface, an identifier associated with a payee having provided an item to the payor, wherein the payee does not have an account associated with the payment service;
dynamically selecting, based at least in part on the identifier, a payment flow of a plurality of payment flows to initialize, wherein individual payment flows correspond to individual types of the plurality of payee types, and wherein the selected payment flow utilizes an interface to enable the payment service to facilitate payments to external services;
based at least in part on the dynamically selecting:
requesting, via the user interface, additional information from the payor, the additional information identifying an interaction between the payor and the payee; and
initializing the interface to enable the payment service to facilitate the payment to an external service with which the payee has an account; and
causing funds to be withdrawn from a stored balance associated with the account of the payor and transferred to the account of the payee via the interface without leaving the payment application.

2. The method of claim 1, further comprising:
sending the identifier to the external service via the interface; and
receiving, via the interface, a confirmation that the identifier is associated with the external service and a request for the additional information from the payor.

3. The method of claim 1, further comprising:
comparing the identifier to one or more identifiers associated with the external service stored in a data store maintained by the payment service, wherein one or more of the stored identifiers are stored in the data store based on having been received in association with one or more previous transactions between the payee and one or more users of the payment service, respectively; and
dynamically selecting the payment flow based at least in part on the comparison.

4. The method of claim 1, further comprising:
dynamically selecting the payment flow based at least in part on an analysis by a machine-learning model trained to identify identifiers associated with the external service based on one or more other identifiers received in association with one or more previous transactions between the payee and one or more users of the payment service.

5. A method for facilitating recurring payment transactions to an external service utilizing a payment application, comprising, by a payment service system associated with a payment service:
receiving, by the payment service system, a request to execute a payment transaction between a payor and a payee, wherein the request is received from a payment application executing on an electronic device associated with the payor;
in response to receiving the request, identifying, by the payment service system, and based on an identifier associated with the payee, a payee type of a plurality of payee types for the payee, wherein the payee type corresponds to a service provider having a payee account external to the payment service;
generating, by the payment service system, and based on the identified payee type for the payee, a transaction flow for executing the payment transaction, wherein the transaction flow comprises a customized sequence of user interactions to be performed to complete an execution of a payment transaction between a payor having an account internal to the payment service and a payee having an account external to the payment service; and
in response to receiving one or more user inputs corresponding to a performance of the customized sequence of user interactions, executing, by the payment service system, the payment transaction by causing funds to be withdrawn from the payor account internal to the payment service and transferred to the payee account external to the payment service.

6. The method of claim 5, wherein the payment transaction is one of a series of recurring payment transactions associated with ongoing provision of goods or services from the payee to the payor.

7. The method of claim 5, wherein the identifier associated with the payee comprises one or more of a name of the payee, a category of the payee, an address of the payee, a phone number of the payee, an email address of the payee, a digital signature of the payee, an image identifier associated with the payee, a tag identifier associated with the payee, a matrix barcode associated with the payee, an account number of the payee, an issuer identification number (IIN) associated with the payee, a bank identification number (BIN) associated with the payee, a logo associated with the payee, a trademark symbol associated with the payee, a stock trading ticker associated with the payee, or a branding association indicator of the payee.

8. The method of claim 5, further comprising receiving a user input corresponding to one or more of a biller code, a customer reference number, an account number, a personal identification number (PIN), an image, or a biometric identifier as the one or more user inputs.

9. The method of claim 5, further comprising:
dynamically selecting, based on the one or more identifiers associated with the payee, a transaction flow of a plurality of transaction flows to initialize, wherein the selected transaction flow utilizes an interface to enable the payment service to facilitate recurring payment transactions to external services without leaving the payment application.

10. The method of claim 9, further comprising:
deriving, by the payment service system, in real-time and based on the identified payee type for the payee, a customized transaction flow for executing the payment transaction in accordance with the identified payee type, wherein the customized transaction flow is derived by combining processes associated with one or more of the plurality of transaction flows.

11. The method of claim 5, further comprising:
identifying the payee type based on:
accessing context data associated with at least the payee;
inputting the context data into an artificial intelligence model trained to generate a prediction of payee type based on the context data associated with a payee; and
outputting, by the machine-learning model, the prediction of a payee type for the payee based on the context data.

12. The method of claim 11, wherein the context data comprises one or more identifiers associated with the payee type for the payee, an amount of the payment transaction, a date of the payment transaction, a time of the payment transaction, payment history of the payor, one or more recent interactions between the payor and a web application, an entry point from which the payor accessed the payment service application, one or more attachments associated with the payment transaction, one or more text-based descriptors associated with the payment transaction, or one or more image-based descriptors associated with the payment transaction.

13. The method of claim 5, further comprising receiving the request to execute the payment transaction between the payor and the payee from a user interface of the payment application enabling payment to at least the identified payee type and a second payee type corresponding to a second user having a payee account internal to the payment service.

14. The method of claim 5, wherein the additional information identifies a customer account associated with the payor, goods or services provided by the payee to the payor, or an invoice from the payee.

15. A payment service system comprising one or more processors and a memory coupled to the one or more processors comprising instructions executable by the one or more processors, the one or more processors being operable when executing the instructions to perform operations comprising:
receiving, by the payment service system, a request to execute a payment transaction between a payor and a payee, wherein the request is received from a payment application executing on an electronic device associated with the payor;
in response to receiving the request, identifying, by the payment service system, and based on one or more identifiers associated with the payee, a payee type of a plurality of payee types for the payee;
generating, by the payment service system, and based on the identified payee type for the payee, a transaction flow for executing the payment transaction, wherein the transaction flow comprises a customized sequence of user interactions to be performed to complete an execution of a payment transaction between a payor having an account internal to the payment service and a payee having an account external to the payment service; and
in response to receiving one or more user inputs corresponding to a performance of the customized sequence of user interactions, executing, by the payment service system, the payment transaction by causing funds to be withdrawn from the payor account internal to the payment service and transferred to the payee account external to the payment service.

16. The payment service system of claim 15, wherein the payment transaction is one of a series of recurring payment transactions associated with ongoing provision of goods or services from the payee to the payor.

17. The payment service system of claim 15, wherein the identifier associated with the payee comprises one or more of a name of the payee, a category of the payee, an address of the payee, a phone number of the payee, an email address of the payee, a digital signature of the payee, an image identifier associated with the payee, a tag identifier associated with the payee, a matrix barcode associated with the payee, an account number of the payee, an issuer identification number (UN) associated with the payee, a bank identification number (BIN) associated with the payee, a logo associated with the payee, a trademark symbol associated with the payee, a stock trading ticker associated with the payee, or a branding association indicator of the payee.

18. The payment service system of claim 15, the operations further comprising:
receiving a user input corresponding to one or more of a biller code, a customer reference number, an account number, a personal identification number (PIN), an image, or a biometric identifier.

19. The payment service system of claim 15, the operations further comprising:
identifying the payee type based on:
accessing context data associated with at least the payee;
inputting the context data into an artificial intelligence model trained to generate a prediction of payee type based on the context data associated with a payee; and
outputting, by the machine-learning model, the prediction of a payee type for the payee based on the context data.

20. The payment service system of claim 19, wherein the context data comprises one or more identifiers associated with the payee type for the payee, an amount of the payment transaction, a date of the payment transaction, a time of the payment transaction, payment history of the payor, one or more recent interactions between the payor and a web application, an entry point from which the payor accessed the payment service application, one or more attachments associated with the payment transaction, one or more text-based descriptors associated with the payment transaction, or one or more image-based descriptors associated with the payment transaction.
